(19) United States
(12) Patent Application Publication
(10) Pub. No.: US 2024/0246155 A1
(43) Pub. Date: Jul. 25, 2024

(54) A CNC MACHINING APPARATUS AND USES THEREOF

(71) Applicant: Søren LUJA HANSEN, Odense C (DK)

(72) Inventor: Søren LUJA HANSEN, Odense C (DK)

(21) Appl. No.: 18/562,162

(22) PCT Filed: Jun. 20, 2022
(86) PCT No.: PCT/EP2022/066650

§ 371 Date: Nov. 17, 2023

(30) Foreign Application Priority Data
Jun. 30, 2021 (DK) PA202170342

(51) Int. Cl. B23B 7/12; B23B 5/28

(52) U.S. Cl. CPC B23B 7/12; B23B 5/28

(57) ABSTRACT

A CNC machining apparatus (14) is configured for machining a rotating part (3;4) of an object (2) by comprising a hinge member (15) adapted to be secured to the object (2) and a CNC X-Y table (16,17,18) securable to the hinge member (15). The CNC X-Y table (16,17,18) comprises a CNC base (16), which is adapted for being rotationally secured to the hinge member (15), a lower linear slide mechanism (17) adapted to be secured in a selected lower working position on top of the CNC base (16), and an upper linear slide mechanism (18) adapted to be secured in a selected upper working position on top of the lower linear slide mechanism (17). The CNC machining apparatus can be used to crown pulley wheels of a band saw while the pulley wheels remain mounted on the band saw. The CNC machining apparatus can also be used on a bench as part of a turning lathe (128).

The present invention relates to an improved CNC machining apparatus configured for machining a rotating part of an object.

In particular the present invention relates to an improved CNC machining apparatus adapted for crowning pulley wheels, in particular for crowning pulley wheels of a band saw without said pulley wheels need to be demounted the band saw during crowning.

The present invention also relates to the band saw provided with the CNC machining apparatus and a turning lathe provided with the CNC machining apparatus.

The applicant's international patent application no. PCT/DK2004/000535 relates to a method and apparatus for crowning band saw pulley wheels.

A base plate is bolted to the band saw, and a base fixture is bolted to said base plate. The base fixture is then aligned with the axis of the pulley wheel to be machined. The CNC X-Y table has a CNC base plate, which is designed to be mounted on e.g. the various locations on the object, a lower slide plate, and an upper slide plate. The CNC base plate is attached to the base fixture via a hinge plate which rotates about a pin. The hinge plate allows the CNC base plate to be aligned such that one axis of the CNC base plate is perpendicular to the axis of the pulley wheel to be machined. The angle of the hinge plate is then pivoted to be aligned such that the other axis of the CNC base plate is parallel to the axis of the pulley wheel to be machined.

The CNC base plate and the lower slide plate are interconnected in that rails on the CNC base plate engage with grooves on the lower slide plate to allow said lower slide plate to slide along the rails along the X-axis perpendicular to the axis of the pulley wheel to be machined. The lower slide plate and the upper slide plate are also interconnected due to the upper slide plate has a rail that engages with a groove on the lower slide plate thereby allowing the upper slide plate to slide along said groove along the X-axis.

During machining a microprocessor controls the two slide plates such that the tool piece follows a path in a 2D plane defined by the X,Y-axes of linear motion of the upper and the lower slide plates.

In the context of describing this known apparatus the terms “lower” and “upper” refer to the position of a slide plate in relation to the CNC base plate,—thus “lower” means closest to the CNC base plate and “upper” means farthest from the CNC base plate. The rail on the upper slide plate provides the X-axis of motion, which X-axis is arranged such that it is parallel to the axis of the pulley wheel. The free end of the upper slide plate that faces the pulley wheel, in the mounted position of the apparatus, carries the tool piece that performs the machining action. An electric motor, e.g. a servo motor, is connected to the lower slide plate to control the motion of the lower slide plate in the Y-axis direction of motion. Another electric motor, e.g. another servo motor, is connected to the upper slide plate to control the motion of the upper slide plate in the X-axis direction of motion.

In the following the X-axis direction of motion and the Y-axis direction of motion are simply referred to as the X-axis or the X-axis direction, and the Y-axis or the Y-axis direction, respectively.

The advantage of the above mentioned known apparatus of PCT/DK2004/000535 is that it can be mounted on the band saw to crown pulley wheels without said pulley wheels need to be demounted the band saw. One of several major disadvantages of this known apparatus is however the substantial space it requires to be operatable when mounted on a band saw fitted with all its equipment. In particular the actuator means that operates the lower slide plate to move along the Y-axis has a length so that it protrudes substantially from the lower base plate when the CNC X-Y table is mounted to the band saw in order for the actuator means to be free to operate.

A further disadvantage is the rather long distance between the electric motor(s) and the suspension point of the apparatus to the band saw, which long distance induces vibrations on the operating tool piece placed on the free end of the upper slide plate. These vibrations influence on the quality of the machining process and to the time consumption to do the machining process correctly. Many calibrations of the control system are needed due to the CNC machining apparatus being so long that it yields during operation.

Yet a further disadvantage is that the edge of the tool pieces ruffles at high revolutions of the pulley wheel during machining. This is today to some degree solved by reducing the rotational speed of the pulley wheels but the downside is that the machining time must be extended and machining costs are substantially increased.

Yet a further disadvantage is the challenges when aligning the CNC X-Y table with its target to be machined.

It is a main aspect of the present invention to provide a CNC machining apparatus that remedies at least some of the disadvantages and downsides experienced by the known apparatus described above.

In a further aspect of the present invention is provided a CNC machining apparatus that is more compact than hitherto known.

In a further aspect of the present invention is provided a CNC machining apparatus with an improved machining accuracy, improved precision of machining, and when in operative mode has a reduced level of vibrations compared to known CNC machining apparatuses.

In a further aspect of the present invention is provided a CNC machining apparatus that is fast to mount on the object and adjust in alignment with the target to be machined.

In a further aspect of the present invention is provided a CNC machining apparatus that can be mounted on the object using a minimum of tools.

In a further aspect of the present invention is provided a CNC machining apparatus that can be mounted with its sliding parts closer to the object and to the rotating part to be machined than hitherto known.

In a further aspect of the present invention is provided a CNC machining apparatus that can be used to machine parts rotating at high rotational speed without negatively influencing the high quality machining.

In a further aspect of the present invention is provided a CNC machining apparatus that suppresses vibrations of the drive system of the object in order to achieve high speed and high precision machining.

In a further aspect of the present invention is provided an improved laser pointer assembly for a CNC machining apparatus.

The novel and unique features whereby these and other aspects are achieved according to the present invention consist in the provision of a CNC machining apparatus that comprises:
a hinge member adapted to be secured to the object,
a CNC X-Y table securable to the hinge member,
   wherein the CNC X-Y table comprises
a CNC base which is adapted for being rotationally secured to the hinge member,
a lower linear slide mechanism adapted to be secured in a selected lower working position on top of the CNC base,
the lower linear slide mechanism comprises a lower slide having a lower slide axis defining the X-axis and being arranged to slide in relation to the CNC base,
an upper linear slide mechanism adapted to be secured in a selected upper working position on top of the lower linear slide mechanism,
the upper linear slide mechanism comprises an upper slide having an upper slide axis defining the Y-axis and being arranged to slide perpendicular to the lower slide,
   and
at least one tool piece which is attachable to the upper slide.

In the context of the present invention the term “lower” means closest to a securing point, site or area of the apparatus on the object, and the term “upper” means farthest therefrom. In this sense the upper slide is arranged on top of the lower slide, which lower slide is secured to the hinge member, which hinge member is secured to the object so that the at least one tool piece is directed towards the part of the object to be machined, and so that the lower slide is able to move along the X-axis and the upper slide is able to move along the Y-axis.

The term “CNC X-Y table” should be interpreted in a broad sense, but in essence the term refers in the context of this invention to an apparatus, which can be programmed to move a tool piece in two linear sliding motions along respective linear paths on a 2D plane,—an X,Y plane —, in which the X-axis is parallel to the rotation axis of the part of the object that is to be machined, and the Y-axis is perpendicular to said rotating axis in said 2D plane. The term “linear” signifies that a linear motion in said two axes in the horizontal plane is performed, either simultaneously or individually independent. Thus the lower slide is arranged perpendicular to the upper slide in the 2D plane.

In the CNC machining apparatus known from the applicant's international patent application no. PCT/DK2004/000535 discussed above the lower linear slide mechanism is arranged to slide the lower slide along the Y-axis, and the lower linear slide mechanism protrudes substantially from the band saw perpendicular to the rotation axis of the pulley wheel, which causes vibrations and results in uneven machining. Uneven chip thickness results in unacceptable machining quality.

In comparison to this known CNC machining apparatus, the lower slide of the lower linear slide mechanism of the CNC machining apparatus of the present invention is arranged so that said lower slide instead is moveable along the X-axis, and the upper slide of the upper linear slide mechanism of the CNC machining apparatus of the present invention is moveable along the Y-axis in the 2D plane. This arrangement provides a more compact design of the CNC machining apparatus of the present invention than of the prior art CNC machining apparatus, and moves the upper slide, that is the slide carrying the tool piece, in direct contact with the rotating part of the object, closer to the object during machining thereby stabilizing the entire assembled structure of apparatus and object. Cantilevering of operative components of the CNC machining apparatus is substantially reduced.

Furthermore, the more compact design of the CNC machining apparatus is highly favorable when the CNC machining apparatus is to be mounted between many components and equipment arranged on an object having a rotating part to be machined, e.g. a pulley wheel of a band saw. When using the CNC machining apparatus of the present invention to e.g. crown the pulley wheels of a band saw fewer or even no equipment needs to be removed from the band saw in order to have sufficient space during mounting said CNC machining apparatus to the band saw, and for unhindered operation of the CNC machining apparatus once mounted and running. Use of the CNC machining apparatus of the present invention thus saves the operator a lot of time to crown the pulley wheel, as well as downtime of the band saw is substantially reduced, whereby considerable maintenance costs are saved.

The hinge member serves to arrange the CNC X-Y table, and thus the at least one tool piece, in the correct pivoted position in relation to the part of the object to be machined. The angle of the hinge member can be stepwise adjusted by having a series of predetermined adjusting positions, or be configured to be adjusted in a stepless manner in which an arbitrary position is selected and fixed. The hinge member is pivoted into a position in which the tool piece(s) are in the intended machining angle.

The CNC base may be premade with a plurality of mounting and securing means, e.g. through-holes to receive fasteners, such as screws or bolts, to allow the lower linear slide mechanism of the CNC X-Y table to be mounted to the hinge member in many different positions, thereby also increasing the multiplicity of possible efficient securing positions of the CNC machining apparatus on the object in relation to the part of the object to be machined, e.g. a pulley wheel of a band saw. The CNC base may also serve as an intermediate member between the hinge member and the lower linear slide mechanism to rotate the lower linear slide mechanism, thus the X-plane of the CNC machining apparatus, in alignment parallel with the rotation axis of the rotating part to be machined.

A further means to adjust and maintain the correct machining position of the CNC machining apparatus is achieved by the mutual arrangement of the lower linear slide mechanism, which is adapted to be secured in a selected lower working position on top of the CNC base, and of the upper linear slide mechanism, which is adapted to be secured in a fixed selected upper working position on top of the lower linear slide mechanism to allow the tool pieces to act perpendicular onto the rotating part. Both said linear slide mechanisms have slides that can move independent on each other along a respective axis in the 2D X-Y plane. So also the upper linear slide mechanism with its upper slide can be placed in many different positions on top of the lower linear slide mechanism, thereby even further increasing the multiplicity of possible efficient securing positions and working positions.

The lower linear slide mechanism comprises a lower slide having a lower slide axis defining the X-axis and being arranged to slide in relation to the CNC base when the lower slide is in operation during machining. The upper linear slide mechanism is similarly arranged with an upper slide having an upper slide axis defining the Y-axis and being arranged to slide perpendicular to the lower slide when the upper slide is in operation during machining. At least one tool piece is attachable to the upper slide, directly or indirectly by an intermediate component, and due to the lower slide and the upper slide being moveable in the X-Y plane once their initial fixed mutual working positions have been determined by the operator fast and efficient machining can take place.

By making the X-axis plane the lowest plane instead of the upmost plane, as in the known apparatus of PCT/DK2004/000535, the actual attack points of stresses and forces are brought very close to the rotating plane of the rotating part of the object, so that the cantilevered parts of the CNC machining apparatus, thus any projecting free unsupported part, do not respond, or at least respond less than for the known apparatus of PCT/DK2004/000535, to the forces transferred to it from the rotating part of the object that the CNC machining apparatus machines. When the known CNC machining apparatus is operated the operator typically needs to compensate the vibrations and oscillations by placing his hand on the most cantilevered part to forcingly control and damp said transferred resulting movements in form of oscillations and vibrations, or take other physical measures and/or adjust the control system to avoid such undesired oscillations and vibrations. The adverse vibrating and oscillating reaction are substantially reduced by using the CNC machining apparatus of the present invention.

Advantageously the upper linear slide mechanism may comprise an intermediate component in form of a tool holder for holding the at least one tool piece. The tool holder may be a structural integral part of the upper linear slide mechanism or optionally the tool holder may be detachable from the upper linear slide mechanism to allow various kinds of tool holders to be attached to said upper linear slide mechanism. One or more tool pieces may be fixed or detachable mounted in the tool holder.

A detachable tool holder also provides the possibility of a multiplicity of various orientations in relation to the upper slide, thereby even further increasing the usability and multiplicity of possibilities to fit the CNC machining apparatus on various objects, and to use the CNC machining apparatus in various orientations and positions.

Advantageously the lower linear slide mechanism may comprise a lower slide base member, a lower slide top member and a lower linear actuator at least partly disposed between said lower slide base member and said lower slide top member, wherein the lower slide base member has
first securing means for being secured to the CNC base opposite the hinge member, and
second securing means for securing of a lower slide means,
   the lower slide means comprises
a lower female slide means selectively securable to the lower slide base member,
a lower male slide means configured to slidingly engage with the lower female slide means,
   wherein
the lower linear actuator is operatively connected to the lower male slide means and to the lower slide top member to slide said lower slide top member along the X-axis.

The lower slide base member acts as a base plate for securing of the lower linear actuator between the lower slide base member and the lower slide top member, and is the component that connects the lower linear slide mechanism to the CNC base. The lower slide top member advantageously covers and/or protects said lower linear actuator, e.g. from malfunctioning by being obstructed by chips from the metal cutting, as well as it serves as a mounting base for the upper linear slide mechanism.

The lower male slide means may slidingly engage with the lower female slide means to guide the movement of the lower slide top member in response to actuating the lower linear actuator during machining.

The lower female slide means may comprise at least two lower linear bearing block means having respective lower tracks, wherein the at least two lower linear bearing block means can be arranged in parallel and spaced apart in the Y-axis direction on top of the lower slide base member thereby delimiting a lower space for arranging of at least a part of the lower linear actuator between the at least two lower linear bearing block means. Preferably such a part of the lower linear actuator is at least a part of a lower actuator rod. Preferably the entire lower linear actuator, including its drive means, such as a servo motor or step motor, are arranged in the lower space.

Within the scope of the present invention the term “actuator rod” means any elongate object that can be used to allow another part to travel along its length, such as a drive not. The “actuator rod” may e.g. be a spindle, a push rod, or be a piston.

Preferably the at least two lower linear bearing block means can be comprised of at least two spaced apart sets of lower linear bearing blocks, wherein a set of lower linear bearing blocks each can be comprised of at least two lower linear bearing blocks arranged spaced apart in the X-axis direction on top of the lower slide base member.

In a preferred embodiment the lower female slide means may comprise two sets of lower linear bearing blocks, wherein each set has two lower linear bearing blocks that define cavities in form of lower tracks complementarily shaped to the cross-sectional profiles of the lower male slide means so that said lower male slide means can slide unobstructed in said lower tracks following a smooth translatory motion driven by the lower linear actuator during machining.

To that aspect the lower male slide means may comprise at least two spaced apart lower guide rails slidingly arranged in the respective lower tracks of the at least two lower linear bearing block means. Preferably the lower male slide means has a lower guide rail for each set of linear bearing blocks. A lower face of the lower slide top member may be configured with at least two spaced apart lower guide tracks that can receive said respective at least two spaced apart lower guide rails, to allow said at least two spaced apart lower guide rails to move in a controlled manner along the X-axis, thus along the length of the lower slide top member. A lower bridge member, which can be secured to the lower face of the lower slide top member, preferably secured between the at least two spaced apart lower guide tracks, may be configured to slide along a lower actuator rod of the lower linear actuator in response to operating the lower linear actuator, thereby, due to the coupling with the lower bridge member, bringing the lower slide top member in motion along the X-axis. In contrast to the present invention just one guide rail in the X-axis direction is used in the prior art CNC machining apparatus described above. Utilizing two parallel lower guide rails, as in the present invention, significantly stabilises the CNC machining apparatus of the present invention.

Accordingly, the at least two lower guide rails may be directly or indirectly interconnected by the lower bridge member, which is associated with the lower linear actuator. The lower bridge member may be secured to the lower slide top member to thereby allow the at least two spaced apart lower guide rails to slide inside said respective lower tracks along the X-axis in response to operating said lower linear actuator, whereby the lower slide top member is moved translatory along the lower actuator rod, thus along the X-axis.

Emphasis is made that the arrangement of lower female slide means and lower male slide means could be reversed so that the lower slide means that is/are selectively securable to the lower slide base member is/are the lower male slide means, and the lower slide means configured to slidingly engage with the lower male slide means is/are the lower female slide means. Thus in the latter reversed embodiment the lower female slide means is/are the moveable lower slide means and the lower male slide means are the stationary fixed lower slide means during operation. Same reverse arrangement is applicable for the upper slide discussed below.

The CNC machining apparatus of the present invention may be configured with an upper linear slide mechanism that in a preferred embodiment can comprise
an upper slide base member, an upper slide top member, and an upper linear actuator disposed at least partly between said upper slide base member and said upper slide top member, wherein
the upper slide base member may have a first sliding means in form of at least one upper male slide means, which is configured to slidingly engage with a second sliding means in form of a female slide means of the lower slide top member.

The basic function of the upper linear slide mechanism corresponds to the basic function of the lower linear slide mechanism. One difference is however that the upper slide top member carries the tool holder with the at least one tool piece, and another difference is of course that the upper slide top member moves perpendicular to the lower slide top member along the Y-axis in the X-Y plane.

An upper linear actuator is disposed at least partly between the upper slide base member and the upper slide top member to drive the motion of the tool piece(s) along the Y-axis. The upper linear actuator is protected by the upper slide top member from chips and residues resulting from the machining process. The tool holder may be configured to further cover the free end of the upper slide top member opposite the tool pieces to prevent chips and residues from entering the upper linear slide mechanism.

The first sliding means may be configured to slide the upper slide base member in selected proper positions in relation to the lower top slide member for carrying out the machining to bring the at least one tool piece in machining contact with the rotating part of the object to be machined.

An upper slide means may comprise at least one upper female slide means selectively securable to the upper slide base member, and at least one upper male slide means configured to slidingly engage with the at least one upper female slide means.

In the context of the present invention the term “selectively” means to facilitate a multiplicity of mounting positions. A securing means or fastening means can e.g. be an array or other pattern of holes. The holes on a first component, e.g. the upper slide base member, can easily be aligned with appropriate holes on another component, e.g. the lower slide base member, to secure these two components in any relevant and convenient overlapping relationship and relative working positions, as desired and appropriate, simply using bolts or screws through aligned holes of the opposite arrays or patterns. The selectively assembled components can be arranged in various more or less overlapping configurations.

Because the upper linear actuator can be operatively connected to the at least one upper male slide means and to the upper slide top member it is in a simple manner made possible to slide said upper slide top member along the Y-axis bringing the tool holder and associated tool piece(s) along when the upper linear actuator moves the upper slide top member along the Y-axis.

To facilitate the upper linear slide mechanism to slide in relation to the lower linear slide mechanism, thus slide on top of the lower slide top member, the first sliding means may comprise at least one slide shoe means configured for slidingly engaging with the second sliding means of the opposite lower top slide member, preferably said second sliding means is in form of at least one lengthwise extending slide groove. Preferably the at least one slide shoe means may comprise at least two parallel sets of individually spaced apart slide shoes adapted for engaging two corresponding, similarly parallel, spaced apart slide grooves provided in a free face of the lower top slide member, which allows the upper linear slide mechanism to slide along the X-axis on top of the lower top slide member to adjust the orientation of the at least one tool piece appropriately in front of the rotating object to be machined.

Furthermore, the upper female slide means may comprise at least two upper linear bearing block means having respective upper tracks, wherein the at least two upper linear bearing block means may be arranged spaced apart along the Y-axis on top of the upper slide base member thereby delimiting an upper space for arranging of at least a part of the upper linear actuator between the at least two upper linear bearing block means. Preferably at least an upper actuator rod of the upper linear actuator can be arranged in the upper space.

Preferably the at least two upper linear bearing block means may be comprised of two spaced apart sets of upper linear bearing blocks, wherein a set of upper linear bearing blocks further can be comprised of two upper linear bearing blocks arranged spaced apart along the Y-axis on top of the upper slide base member. This principle of arrangement of the upper linear bearing blocks corresponds to the principle of arrangement of the lower linear bearing blocks and the working principles are the same and will not be described in similar details.

The CNC machining apparatus according to the present invention may comprise that the upper male slide means comprises at least two spaced apart upper guide rails slidingly arranged in the respective upper tracks of the at least two upper linear bearing blocks.

The at least two upper guide rails may be secured to the upper slide top member to slide the at least two spaced apart upper guide rails inside said respective upper tracks along the Y-axis in response to operating the upper linear actuator, thereby also conferring a sliding motion to the tool holder, which is secured to the upper slide top member to be brought along, and thus to the tool piece(s), along said Y-axis, thus moving the tool piece(s) to and from machining contact with the rotating part of the object.

The upper slide top member may have an upper slide top member base plate that on opposite edges along its longitudinal axis extends into respective opposite upper slide top member side plates, thereby defining a cover with an upper U-profile that delimits an upper cavity for protecting and at least partly covering at least parts of the upper linear actuator, the upper female slide means, and the upper male slide means.

The tool holder may be secured to the upper slide top member to secure the position of the at least one tool piece in relation to the rotating part of the object, and to reduce vibrations, oscillations and forces induced on the CNC X-Y table during machining, thereby substantially increasing the machining quality, achieving higher speed of machining, and shorter machining duration compared to the known CNC machining apparatus, and thereby also preserving lifetime of the tool piece(s).

The CNC machining apparatus of the present invention may comprise a lower slide top member base plate that on opposite elongated edges extending along its longitudinal axis extends into respective opposite lower slide top member side plates, thereby defining a lower U-profile that serves as a cover delimiting a lower cavity for at least partly, and preferably fully on the longitudinal sides, covering at least parts of the lower linear actuator, the lower female slide means, and the lower male slide means. The upper face of the lower slide top member base plate may be the part of the lower slide top member base plate configured with the second sliding means.

One or both of the lower bridge member and the upper bridge member can receive a part of a lower linear actuator rod and an upper linear actuator rod, respectively, whereby the bridge members control the position of the actuator rods of the linear actuator means in both the X-direction and the Y-direction, and are keeping the actuator rods suspended and connected to the two opposite lower guide rails and the two opposite upper guide rails, respectively, to move the lower slide top member and the upper slide top member, respectively, to the extent required for performing the machining process during machining.

A laser pointer assembly may be arranged slidingly in the at least one lengthwise extending slide groove of the second sliding means of the lower slide top member, e.g. spaced apart from the upper linear slide mechanism. The laser pointer assembly may stay on the CNC machining apparatus during machining.

The laser pointer assembly can be arranged in a calibrating position secured in said at least one lengthwise extending slide groove or be secured to one of the outer edge of the lower slide top member. The laser pointer assembly serves for aligning the CNC X-Y table into the machining position in which the tool piece can attack its target the best, such as attacking its target perpendicularly. The laser pointer helps in finding and adjusting the most precise location of said tool piece for the machining process.

The laser pointer of the laser pointer assembly can be pivotably mounted to the lower slide top member to provide an even higher degree of freedom for aligning the X-axis of the CNC X-Y table parallel to the rotation axis of the rotating part of the object, and thus the Y-axis perpendicular to the target to be machined.

Advantageously the laser pointer assembly may comprise a hinge and a laser pointer with a laser head, which laser pointer may be suspended to the hinge via a suspension means, which suspension means may comprise an outer turnplate and an inner turnplate that can be rotationally arranged in relation to the outer turnplate about a hinge rotation axis, wherein the outer turnplate can carry the laser head. The rotational arrangement of the outer turnplate in relation to the inner turnplate enables the laser head to be rotated without being detached from the CNC machining apparatus, when the X-axis of the CNC X-Y table is aligned perpendicular to the target to be machined, e.g. a target in form of the rotating part of the object. The laser pointer assembly of the present invention may be used for other applications than together with the CNC machining apparatus of the present invention.

Expediently the CNC machining apparatus according to the present invention may comprise a processor or computer with computer software including algorithms configured to drive the CNC machining apparatus, and a user interface in communication with the computer software for configuring the CNC machining apparatus for a work process in response to user input data, whereby the machining can run automatically. Also the CNC machining apparatus can be configured with computer software and additional drive means for aligning of the CNC X-Y table automatically.

The invention will now be described in further details with reference to the drawing, in which

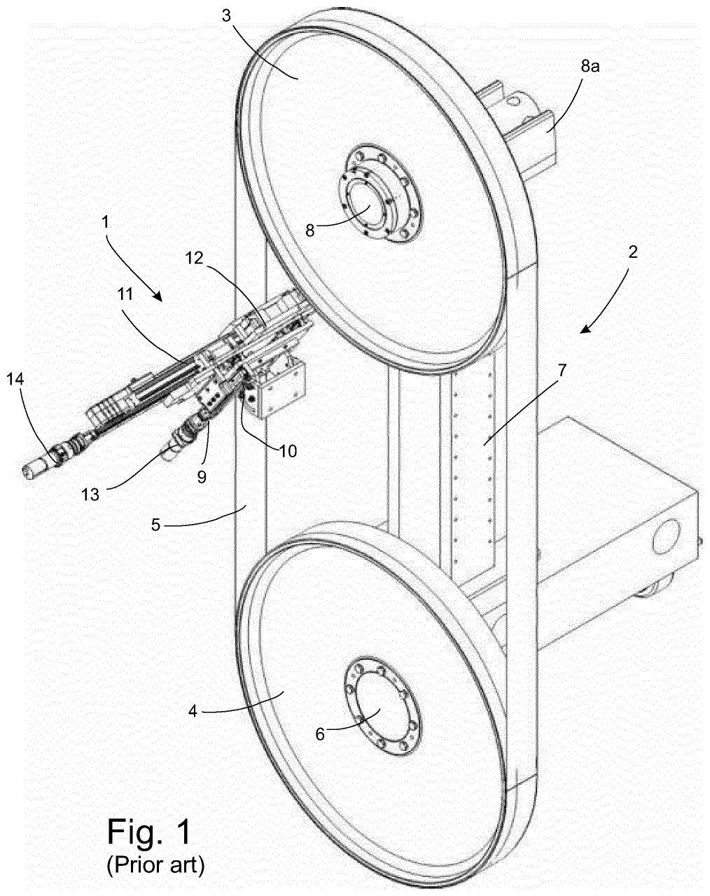

FIG. 1 is a perspective view of the conventional CNC machining apparatus of PCT/DK2004/000535 mounted on a vertical band saw seen from the rear side, and in a mounting position of crowning the upper pulley wheel,

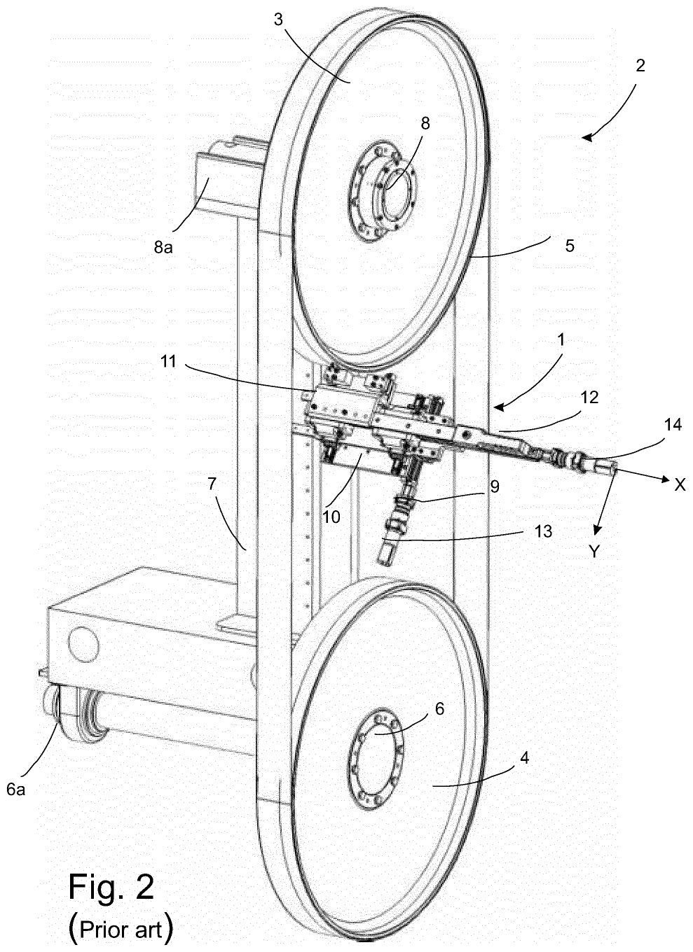

FIG. 2 shows the same seen from the front,

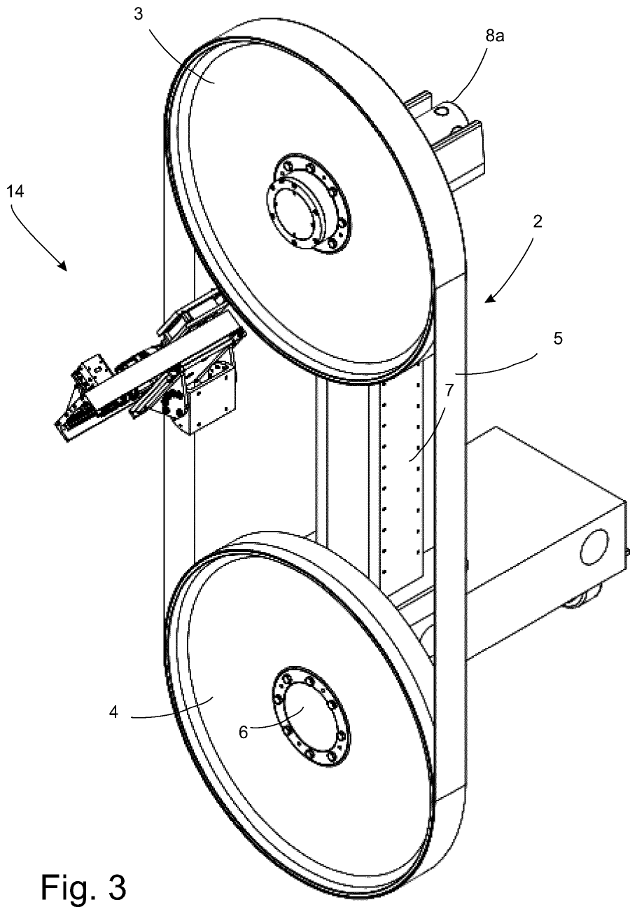

FIG. 3 is a perspective view, which corresponds to FIG. 1, of the CNC machining apparatus of the present invention mounted on a vertical band saw seen from the rear side, and in a mounting position of crowning the upper pulley wheel,

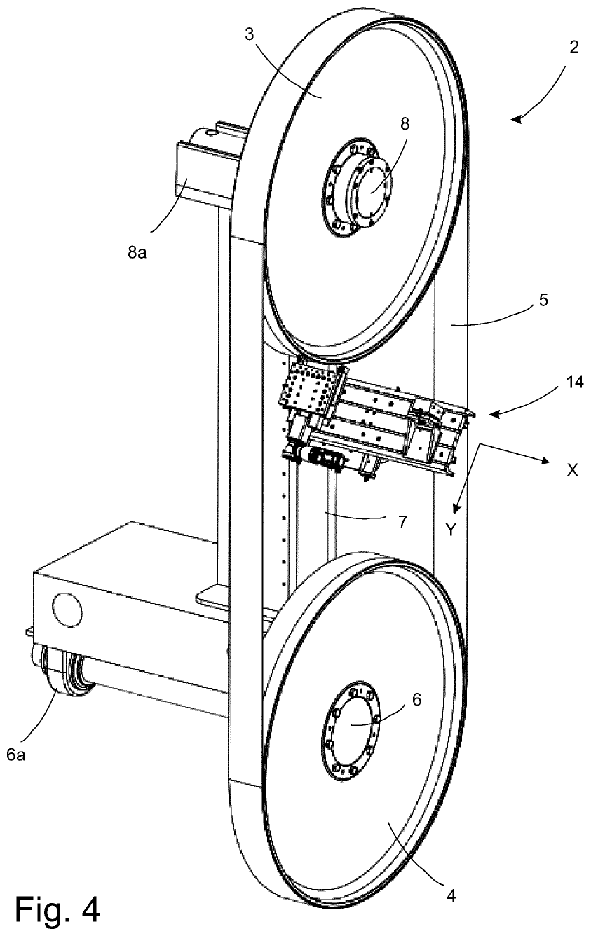

FIG. 4 shows the same seen from the front,

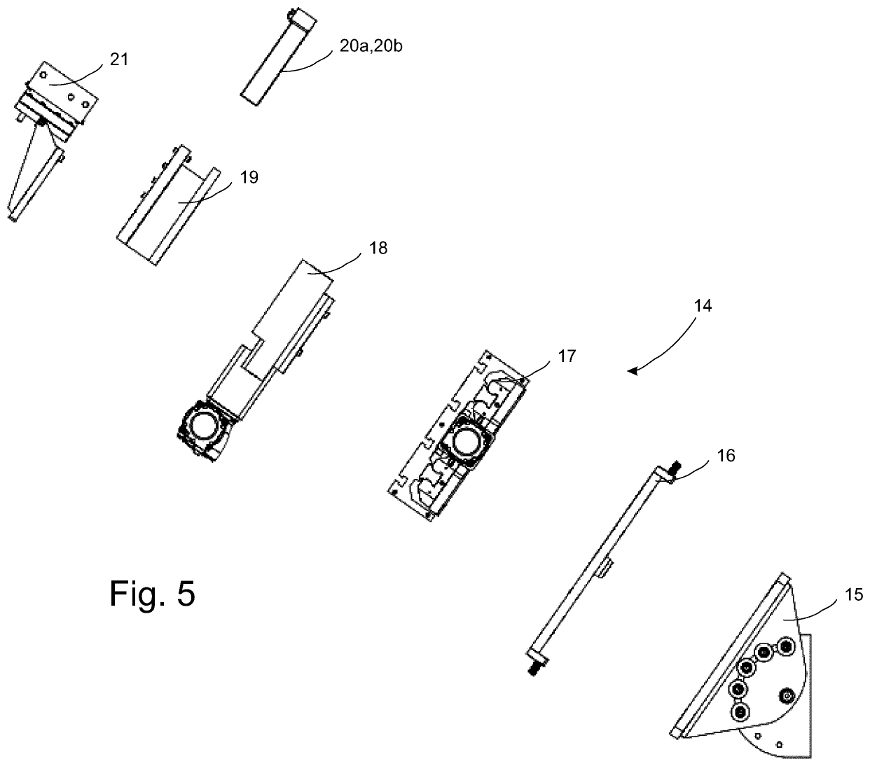

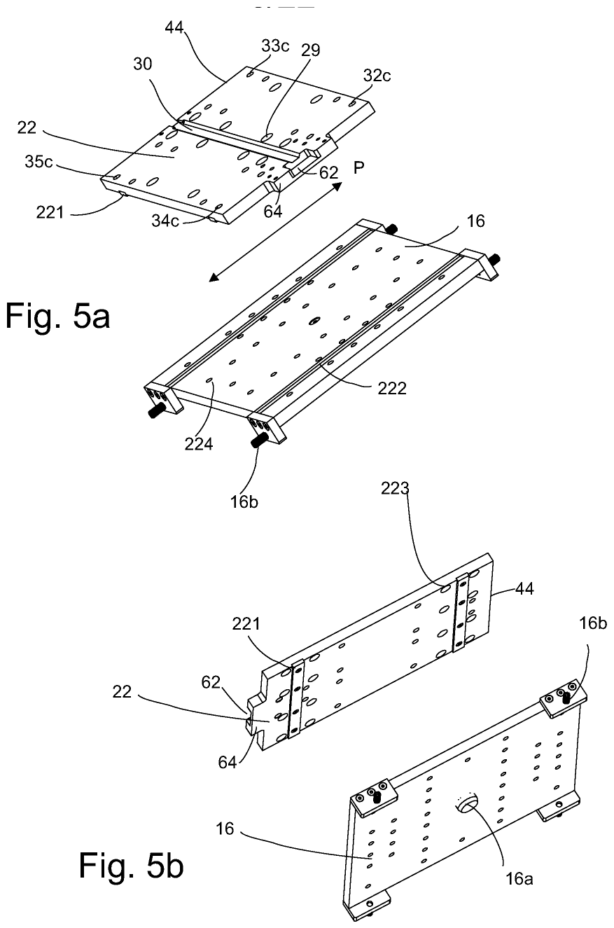

FIG. 5 shows the CNC machining apparatus seen in FIGS. 3 and 4 from the side and in an exploded view,

FIGS. 5a and 5b show the lower slide base member and the CNC base in perspective exploded views from above and from below, respectively,

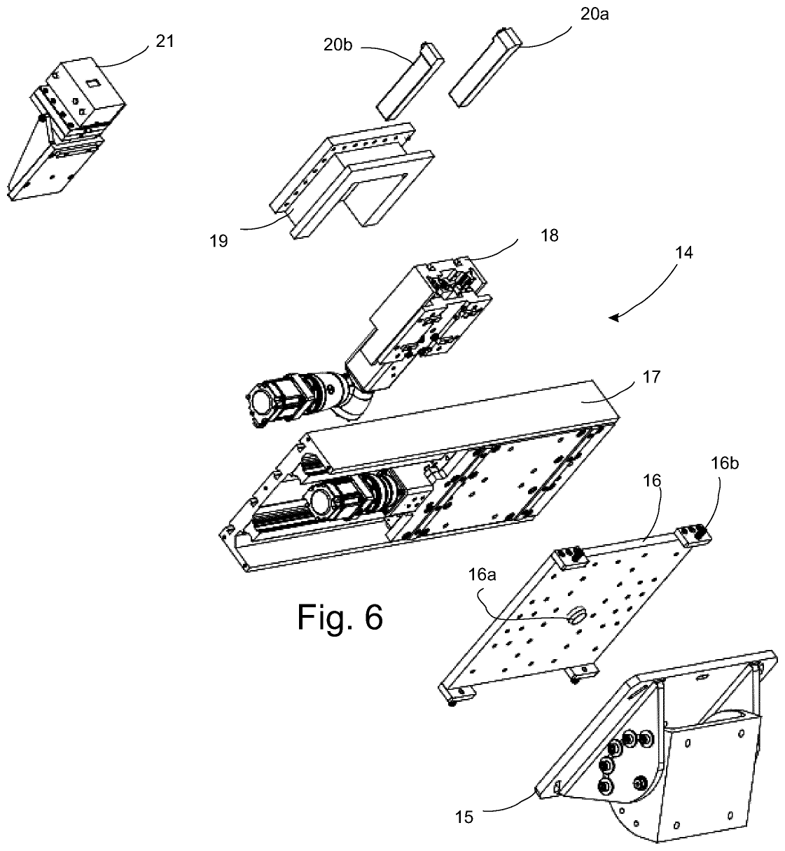

FIG. 6 shows the same in a perspective view seen from below,

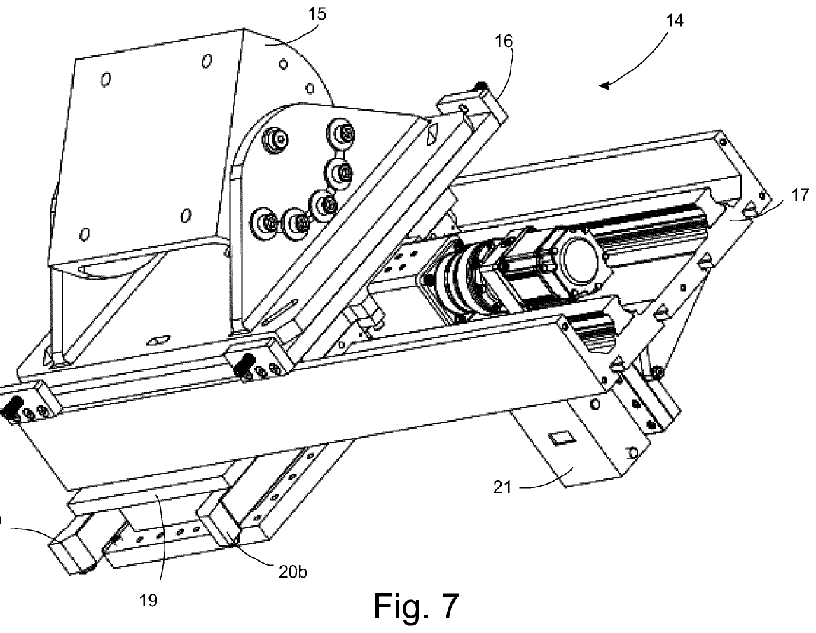

FIG. 7 is a perspective view of the same in assembled state seen from the hinge member,

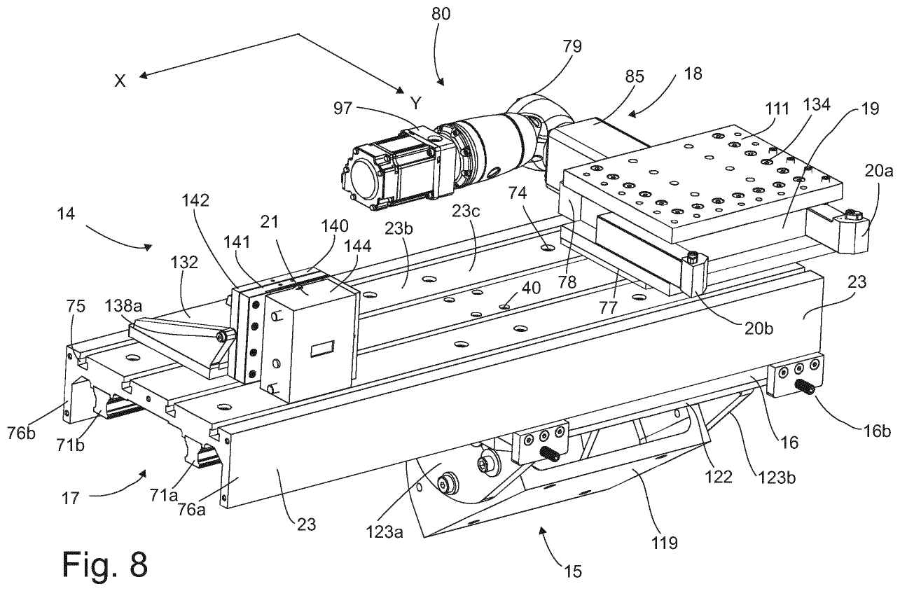

FIG. 8 shows the same seen from above,

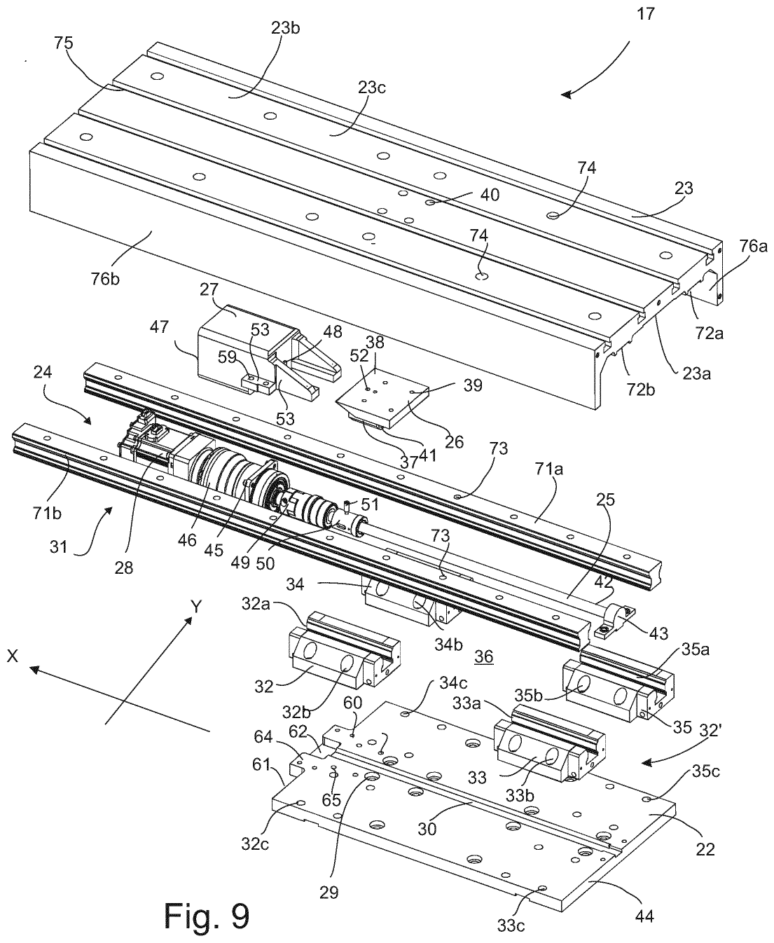

FIG. 9 is an exploded perspective view of the lower linear slide mechanism seen from above,

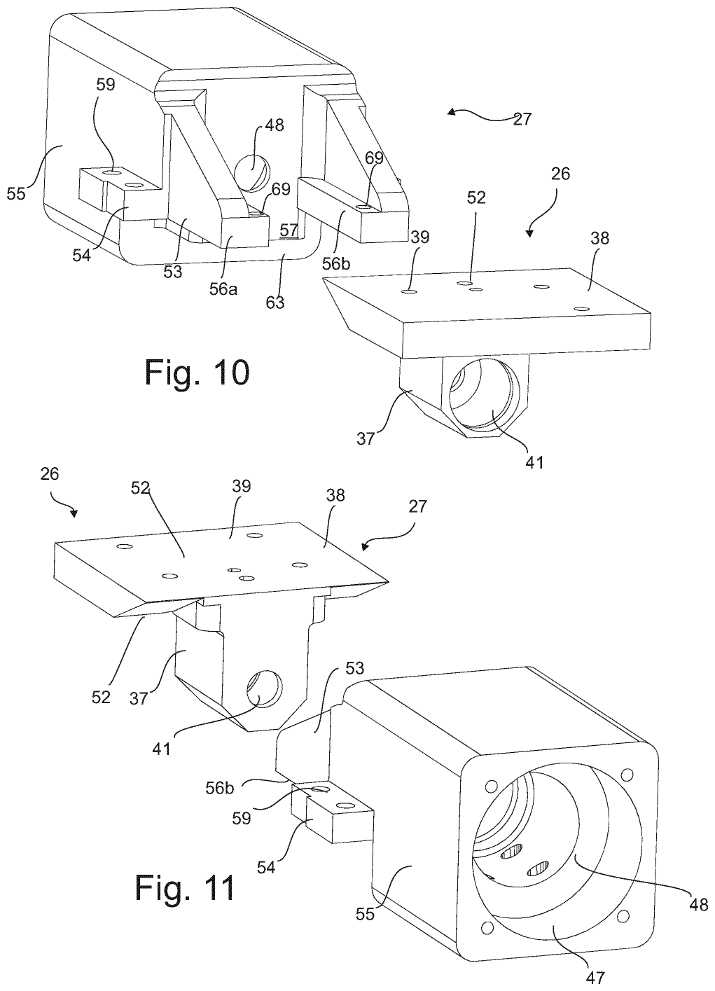

FIG. 10 is an enlarged scale exploded perspective view of the lower bridge member and the lower bearing housing seen from the lower bridge member,

FIG. 11 shows the same seen from the lower bearing housing,

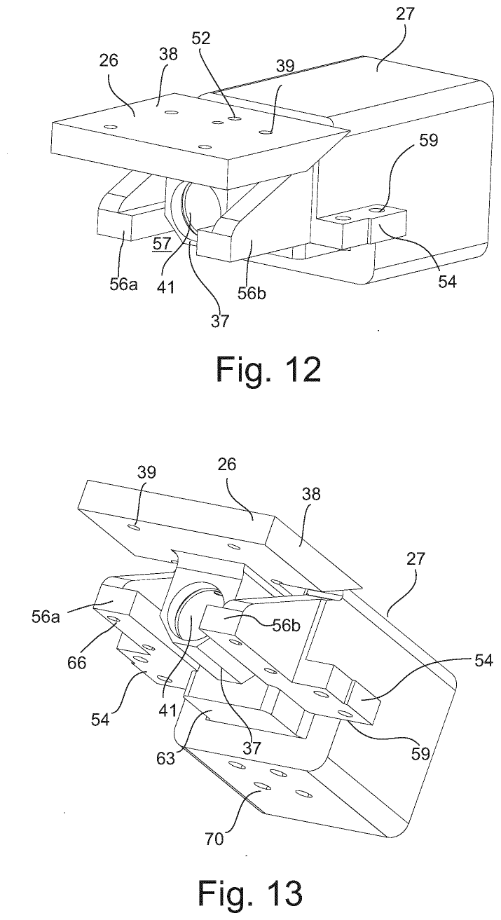

FIG. 12 shows the same but with overlapping lower bridge member and lower bearing housing seen from above,

FIG. 13 shows the same but seen from below,

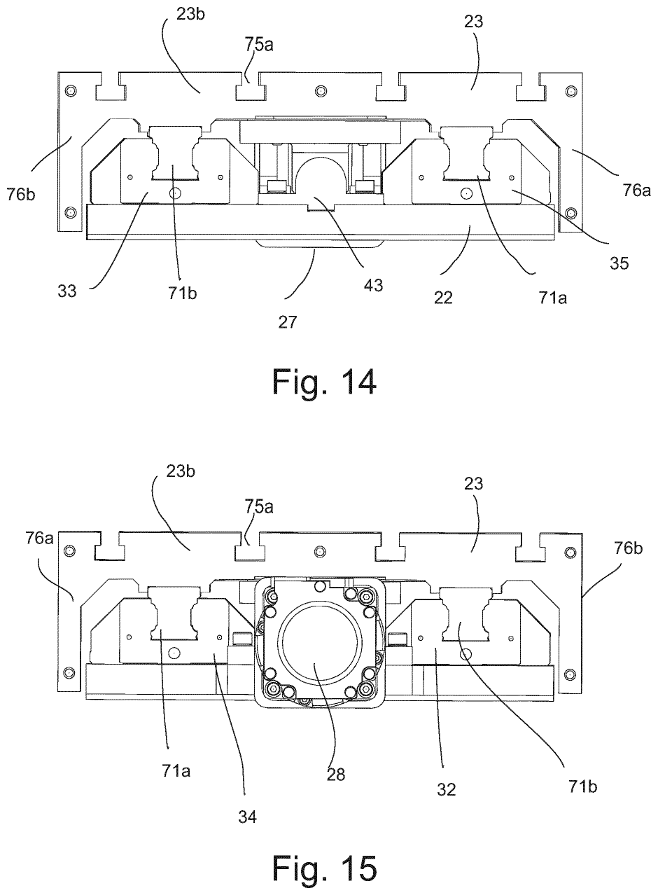

FIG. 14 is an end view of the lower linear slide mechanism seen from opposite the servo motor,

FIG. 15 is an end view of the lower linear slide mechanism seen from the servo motor,

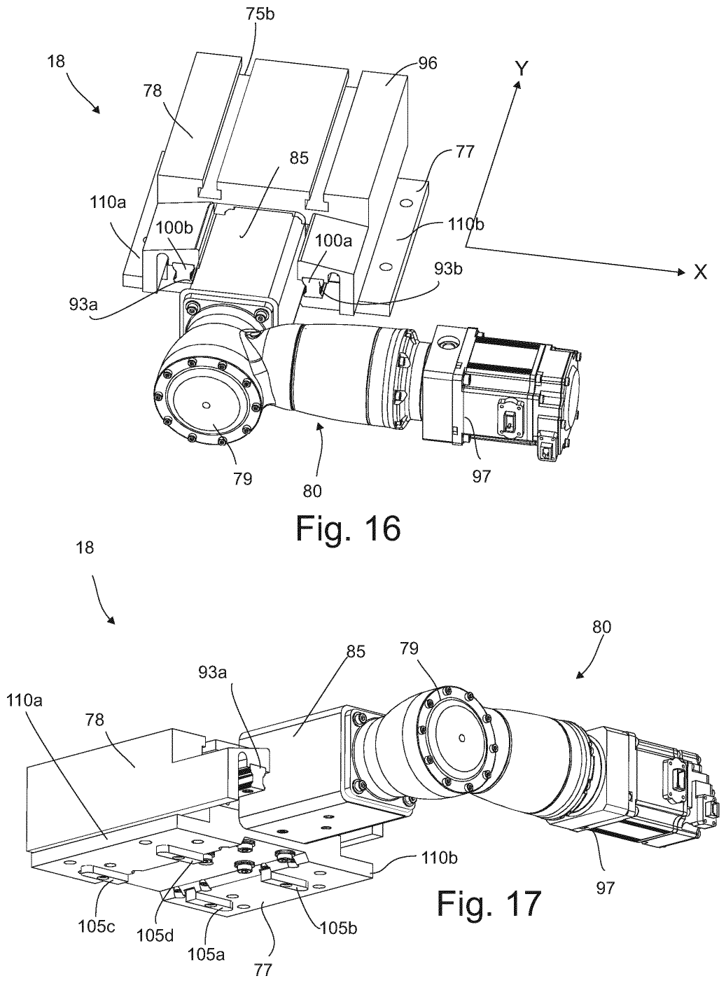

FIG. 16 is a perspective view from above the upper linear slide mechanism,

FIG. 17 shows the same seen from below in assembled state,

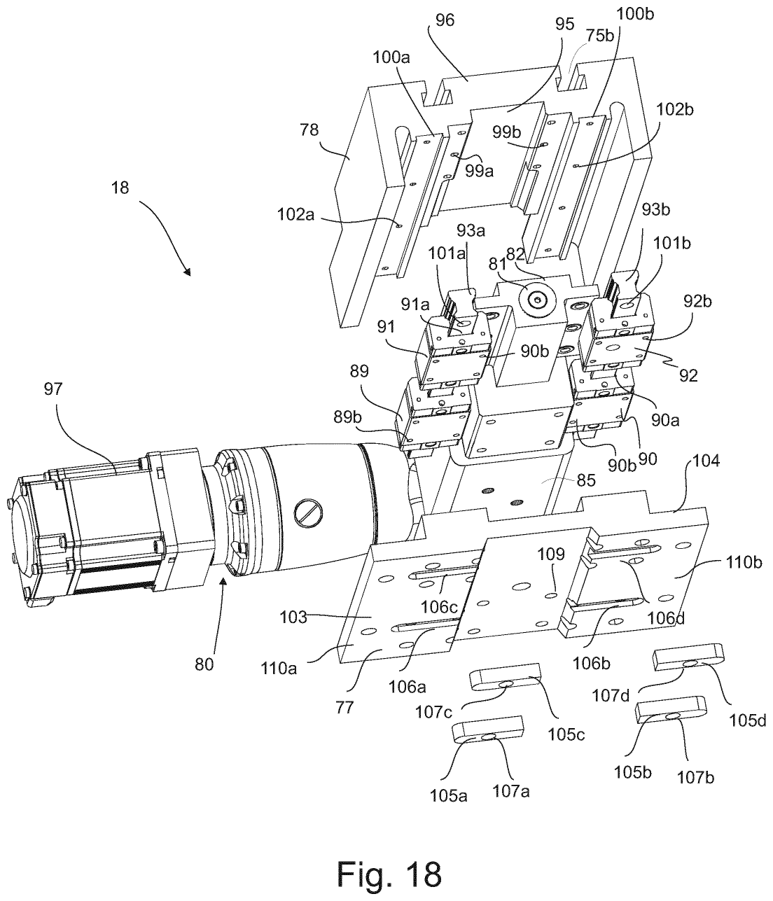

FIG. 18 shows the same seen from below in an exploded view,

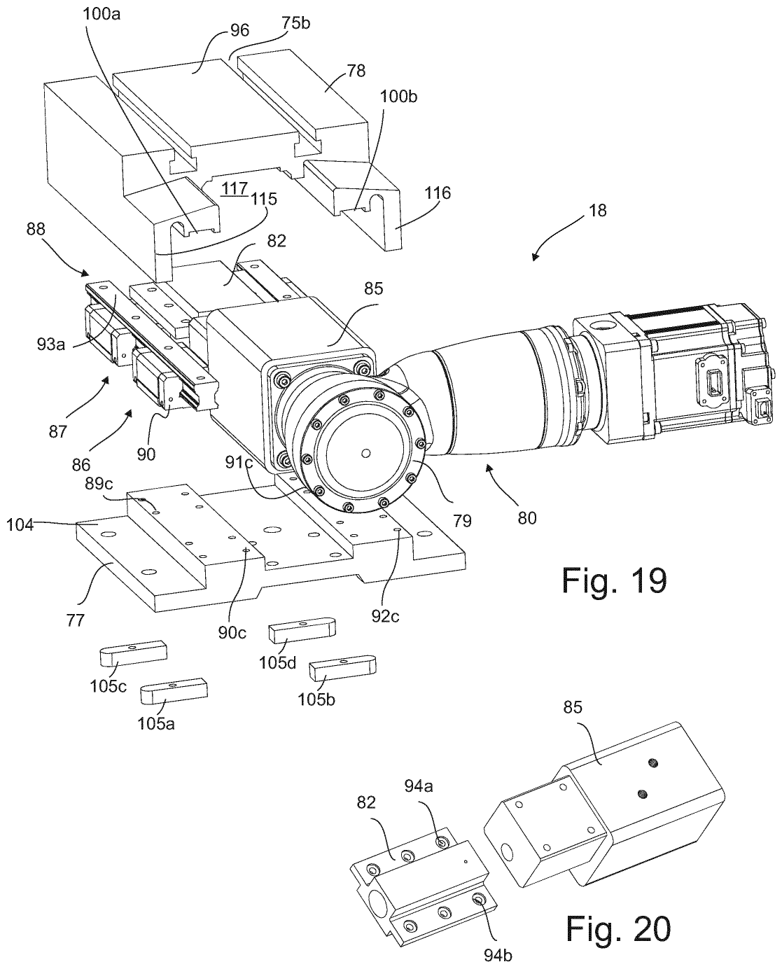

FIG. 19 shows the same seen from above in an exploded view,

FIG. 20 is an exploded perspective view of the upper bridge member and the upper bearing housing seen from below,

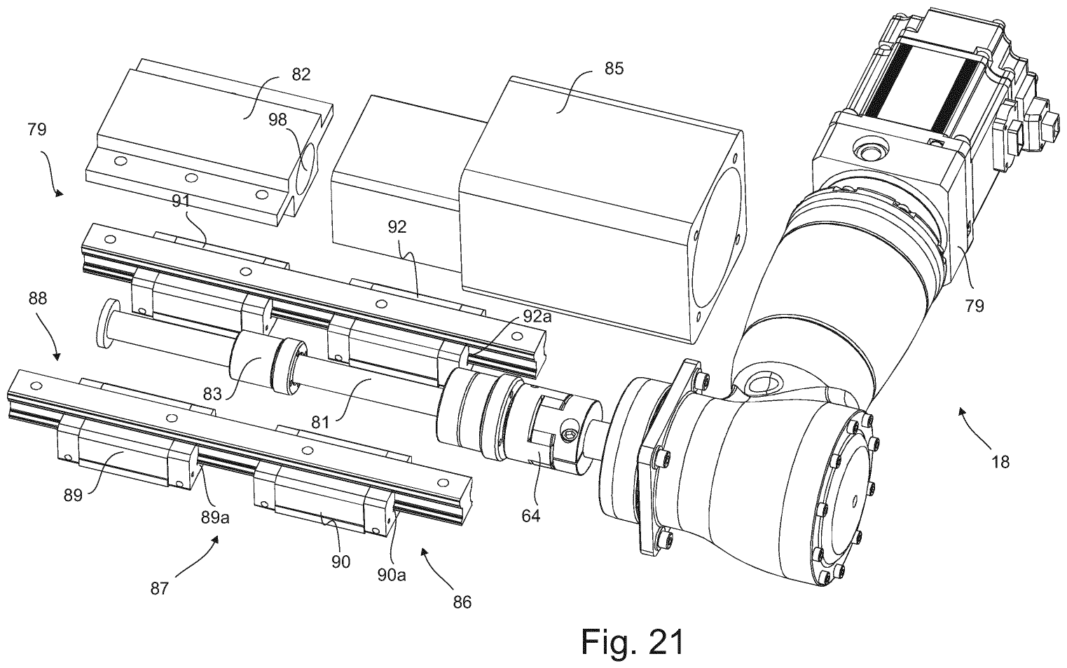

FIG. 21 is an enlarged scale, exploded, perspective view seen from below of the upper linear slide mechanism without the upper slide top member and without the upper slide base member,

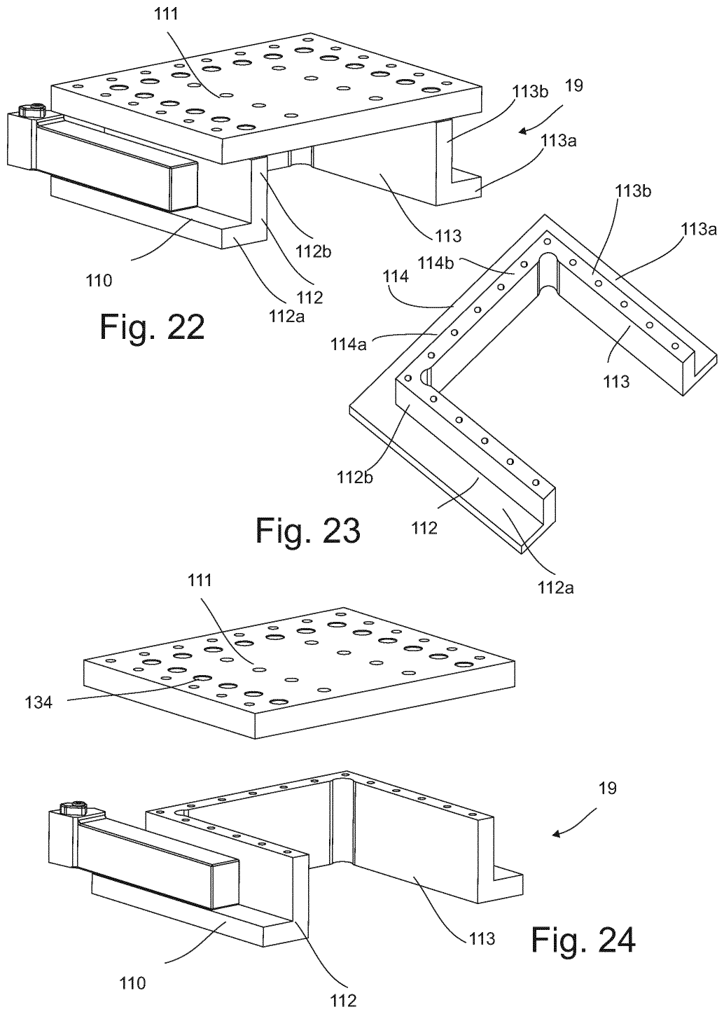

FIG. 22 is an enlarged perspective view of the tool holder with a single tool piece,

FIG. 23 is a perspective view of the lower tool holder part seen from above,

FIG. 24 shows the same as FIG. 23 in a partly exploded view,

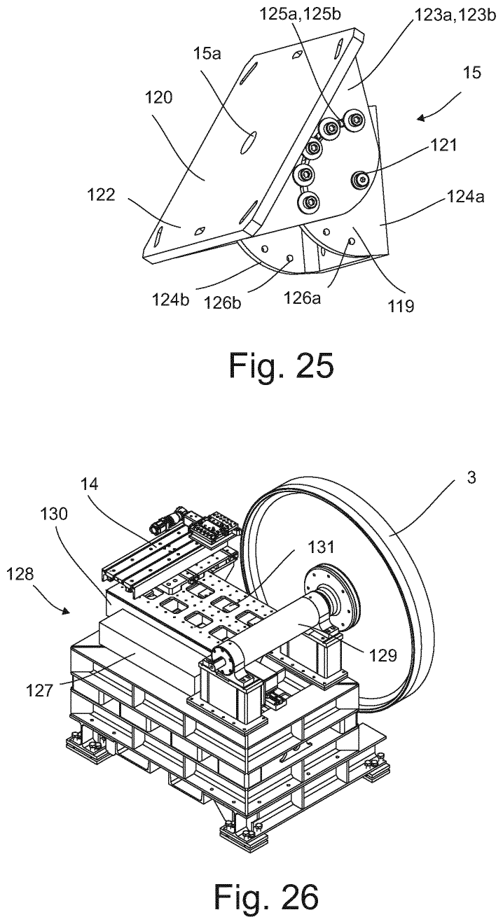

FIG. 25 is an enlarged scale perspective view of the hinge member,

FIG. 26 shows a turning lathe with the CNC machining apparatus according to the present invention in an exemplary mode of operation with the pulley wheel of the band saw seen in FIGS. 1-4,

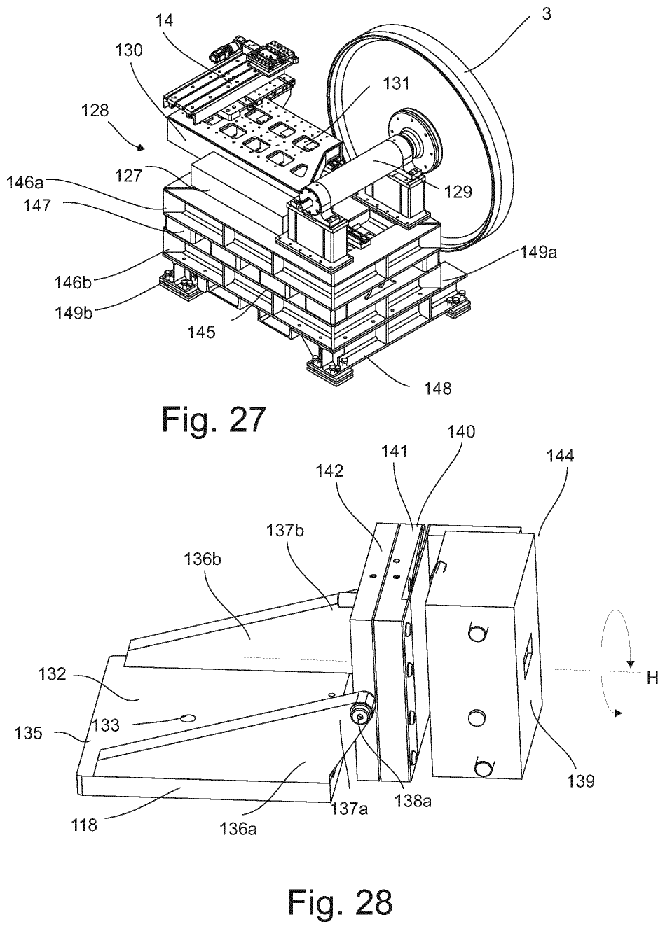

FIG. 27 shows the same but in another mode of operation, in which the turning lathe base has been retracted to machine very large pulley wheels,

FIG. 28 is a perspective view of the laser pointer assembly,

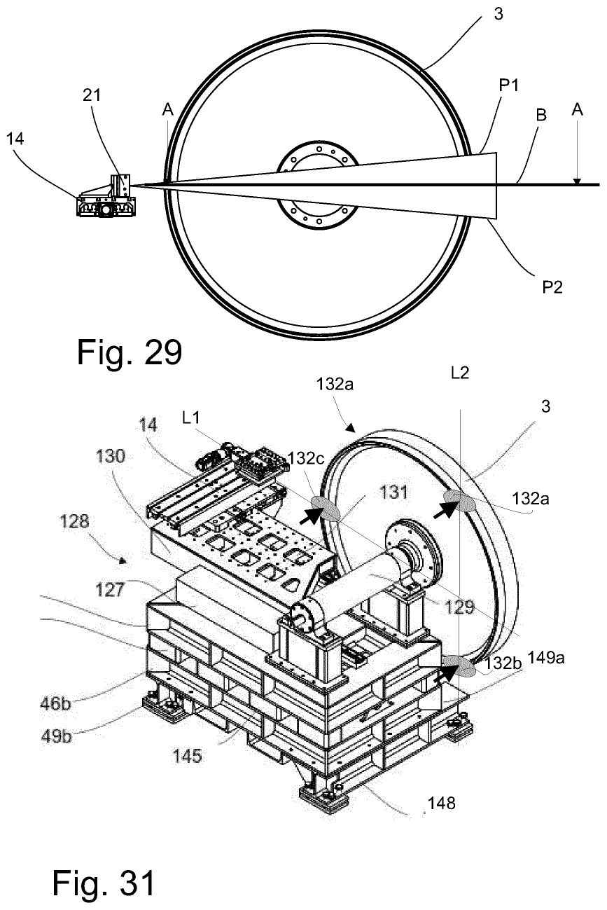

FIG. 29 shows the laser pointer assembly seen from the side on top of the lower linear slide mechanism in a calibration set up,

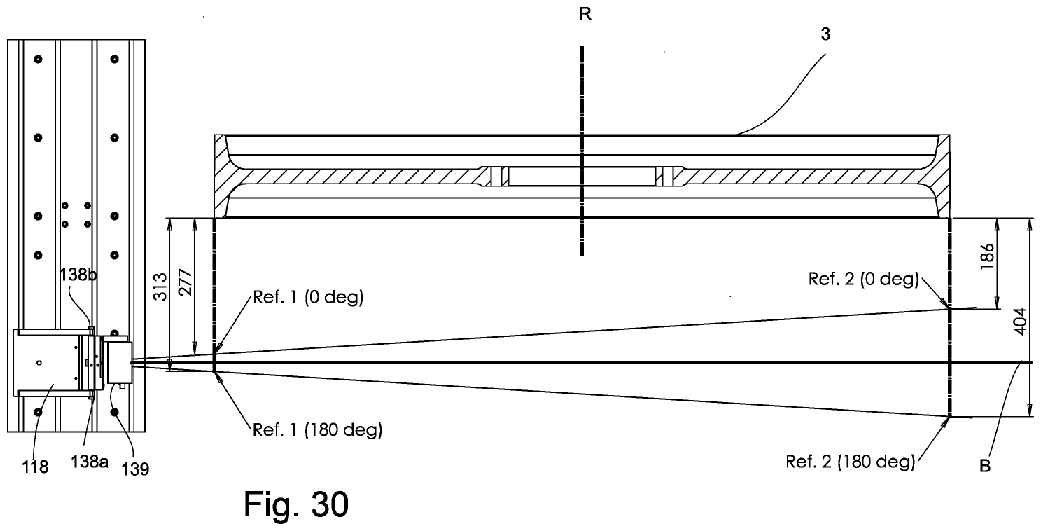

FIG. 30 is a sectional view taken along line A-A in FIG. 29, and in scale 1:7.5, of the laser pointer assembly in a calibration process, thus seen from above with the pulley wheel in sectional view, and without the upper linear slide mechanism, and

FIG. 31 shows the turning lathe of FIG. 27 equipped with vibration damper means.

In FIGS. 1-4 the band saws are shown schematically and in exemplified crowning states without visualizing blade guides, cutting table, gear and other main components that normally are part of the operative band saw, but are independent of and irrelevant for the function of the novel detachable CNC machining apparatus of the present invention. By way of example the CNC machining apparatus are shown in a crowning position in relation to the idle upper pulley wheel 3. The driven lower pulley wheel 4 can of course be crowned in a similar manner, for some band saws even without demounting e.g. one or more of the blade guides and the cutting table. The saw blade may be used to rotate the pulley wheels 3,4 during crowning, or a separate drive belt 5 may be used to drive the pulley wheels 3,4 instead.

The part of the object to be machined is typically rotated by means of the motor that serves for driving the rotating parts of the object into rotation, provided the speed of said motor is adjustable to an appropriate low speed for conducting the machining process. A separate drive belt around the rotated part serves to put the rotating part into rotation. In the alternative a separate motor is used to drive the separate drive belt that drives the rotating part, thus the “target” for the machining process, into rotation. By using a separate drive belt running in the tracks of the pulley wheel's bearing play can be substantially reduced or even eliminated. Yet an alternative is to directly drive the rotating part that needs to rotate in order to be machined, e.g. using a motor driven shaft, e.g. in a bench, as will be described later.

In the context of the present invention the term “linear actuator” should be understood as a means that is able to drive a component along a linear path. Known horizontal linear actuator technology may be used in full or in part. The term “actuator rod” means, in the present context, the part of the linear actuator that can rotate in order to move another component along a respective axis, or aid in guiding, pushing or moving said other component in a linear motion, to either extend or retract said another component by its operative coupling to said “actuator rod”. The “actuator rod” may e.g. be the externally threaded “spindle” that passes through the internally threaded “drive nut” of a conventional linear actuator.

The “bridge member” serves, in the context of the present invention, at least the purpose of an intermediate component that couples the “drive nut” in operative connection with the lower slide top member and the upper slide top member, to make these members to travel along the “actuator rod”, as will be described in further details below.

The drive means are exemplified by an electric motor,—a servo motor —, but this should not be construed as limiting the scope of the present invention. The drive means further includes a drive gear, which in the following is referred to as a “gear box”. The drive gear can be any suitable kind of gear. An exemplary gear box of the lower linear actuator is a planetary gearbox, and an exemplary gear box of the upper linear actuator is a right-angle gearbox. Other arrangements are within the scope of the present invention, including an opposite arrangement in which the gear box of the lower linear actuator is a right-angle gearbox and the gear box of the upper linear actuator is a planetary gearbox. Yet an alternative is that both gear boxes are of same kind.

In the perspective views of the conventional CNC machining apparatus 1 seen in FIGS. 1 and 2, said conventional CNC machining apparatus 1 is mounted on a conventional vertical band saw 2, which is seen from the rear side. The conventional CNC machining apparatus 1 is located in relation to the vertical band saw 2 in a mounting position to crown the idle pulley wheel 3. The drive shaft 6 of the lower pulley wheel 4 is driven by an electric motor (not shown) so that a belt means 5 transfers the rotation of the drive shaft 6 into rotation of the idle upper pulley wheel 3 about its idle shaft 8. The drive shaft 6 and the idle shaft 8 are located in respective shaft bearings 6a,8b, which shaft bearings 6a,8a are mounted on the column 7 of the bands saw 1. The column 7 provides the distance between the pulley wheels 3,4.

The lower linear actuator means 9 of the lower linear slide mechanism 10 protrudes substantially towards the driven pulley wheel 4, which reduces the possible kinds of band saws that can be crowned using this known CNC machining apparatus. The upper linear actuator means 11 of the upper linear slide mechanism 12 protrudes substantially from the rotation plane of the pulley wheels 3,4. Both the lower linear actuator means 9 and the upper linear actuator means 11 are subjected to heavy vibrating induced by the rotating pulley wheels 3,4 during crowning. Each linear actuator means 9,11 has a respective actuator rod and associated drive means, e.g. an electric motor in form of a servo motor, as will be explained in further details in relation to the further figures and to the CNC machining apparatus of the present invention. The lower servo motor 13 of the lower linear actuator means 9 is arranged in a plane highly offset the rotation plane of the pulley wheels 3,4. The upper servo motor 14 of the upper linear actuator means 11 extends as a long cantilevered projection without end support parallel to the rotation axis of the pulley wheels 3,4.

This known CNC machining apparatus requires a lot of free space in order to be fitted correctly to the band saw and for subsequently being able to operate unobstructed. Also the many vibrations and yielding of the CNC machining apparatus influence on the machining quality. Furthermore, the overall huge size makes it heavy for a single person alone to mount it on the band saw. Due to these adverse and uncontrolled effects this procedure requires very special skills and education to do it correct.

FIGS. 3 and 4 are similar views as FIGS. 1 and 2, but of the CNC machining apparatus 14 of the present invention seen on the same band saw 1 and in the same position.

As can be seen in FIGS. 3 and 4 the cantilevering of the linear slide mechanisms of the compact CNC machining apparatus of the present invention is substantially reduced compared to the cantilevering of the known CNC machining apparatus. Also the space requirements for mounting and operating the CNC machining apparatus of the present invention has been substantially reduced compared to the known CNC machining apparatus described in relation to FIGS. 1 and 2.

The structure of the CNC machining apparatus 14 of the present invention and of its parts is shown in more details in the subsequent figures, and described in relation thereto, as an example for crowning the idle pulley wheel 3.

FIG. 5 is an exploded side view of the CNC machining apparatus 14 of the present invention, and FIG. 6 shows the same in perspective view seen slightly from below.

The CNC machining apparatus 14 has a hinge member 15, a CNC base 16, a lower linear slide mechanism 17, an upper linear slide mechanism 18, a tool holder 19 with two tool pieces 20a,20b, and a laser pointer assembly 21.

FIGS. 7 and 8 show the CNC machining apparatus 14 in assembled state, and seen from the hinge member 15 and from the tool holder 19, respectively.

The exploded perspective view of FIG. 9 shows the structural and functional main components of the lower linear slide mechanism 17 in more details.

The lower linear slide mechanism 17 comprises a lower slide base member 22 in form of a plate, a lower slide top member 23 with a U-profile, and a lower linear actuator 24.

The lower linear actuator 24 has a lower actuator rod 25, a lower bridge member 26, which is operatively connected to a lower drive nut 50, a lower clutch mechanism 49 disposed between a lower bearing housing 27 that covers the lower clutch mechanism 49 at least partly, and a lower servo motor 28. The lower bridge member 26 is also operatively connected to a lower face 23a of a lower slide top member base plate 23b of the lower slide top member 23 to bring along said lower slide top member 23 when the lower servo motor 28 of the lower linear actuator 24 is operative. The lower bridge member 26 and the lower bearing housing 27 are seen in more details in the enlarged scale views of FIGS. 10-13.

The lower slide base member 22 has first securing means in form of an array of first through-holes 29, thereby adapting the lower slide base member 22 for being secured to the CNC base 16 opposite the hinge member 15.

As seen in FIGS. 5a and 5b, on the side facing the CNC base 16 the lower slide base member 22 has first positioning means in form of two spaced apart base plate rails 221 that mate into second positioning means in form of two spaced apart CNC base tracks 222 of the CNC base 16, to thereby facilitating setting the position of the lower slide base member 22 and the CNC base 16 in one of plural possible positions in relation to each other, simple by sliding the lower slide base member 22 in the CNC base tracks 222 in one of the directions indicated by double arrow P. The set position can be more or less offset a centered position. The lower slide base member 22 and the CNC base 16 are secured to each other by means of screws or bolts through aligned first positioning holes 223 in the lower slide base member 22 and second positioning holes 224 in the CNC base 16. In the present exemplary embodiment seen in FIGS. 5a and 5b three sets of rows of positioning holes 223,224 are responsible for three differently offset mounting positions between the lower slide base member 22 and the CNC base 16. More or less than three offset mounting positions are within the scope of the present invention.

In FIGS. 5 and 6 the lower slide base member 22 and the CNC base 16 are seen in the most off-centered position.

With further reference to FIG. 9 a lower slide means 31 is comprised of a lower female slide means 32′, which in the present embodiment is comprised of two parallel sets of lower linear bearing blocks 32,33;34,35, each having a respective lower track 32a,33a;34a,35a. Two respective lower linear bearing blocks 32,33 and 34,35 of a set of lower linear bearing blocks 32,33;34,35 are mounted spaced apart along the X-axis on the lower slide base member 22. To that purpose second securing means in form of first mounting holes 32b,33b;34b,35b of said lower linear bearing blocks 32,33;34,35 are aligned with second mounting holes 32c,33c;34c,35c in the lower slide base member 22, whereby the lower linear bearing blocks 32,33;34,35 can be secured to the lower slide base member 22 using screws or bolts (not shown) through said aligned first mounting holes 32b,33b;34b,35b and second mounting holes 32c,33c;34c,35c.

In the present embodiment a set of lower linear bearing blocks 32,33;34,35 each has two lower linear bearing blocks. This should however not be construed as limiting the scope of the present invention. Instead of a set of separate lower linear bearing blocks one unitary lower linear bearing block can be used on opposite sides of the lower actuator rod 25, or a set may be comprised of more than two lower linear bearing blocks. The present exemplary embodiment of a lower slide mechanism is shown to have four lower linear bearing blocks 32,33;34,35 situated in respective corners of the lower slide base member 22. In contrast thereto the known CNC machining apparatus seen in FIGS. 1 and 2 does not have spaced apart parallel sets of lower linear bearing block, but instead is a single set of lower linear bearing block(s) arranged on a central longitudinal axis. Such a single set is significantly less stable than the arrangement of the present invention with two spaced apart parallel sets of lower linear bearing blocks.

The two linear bearing blocks 32,33;34,35 of a set of lower linear bearing block means are arranged axially aligned along the longitudinal axis of the lower slide base member 22, thus along the X-axis of the CNC X-Y table, with a distance inbetween. The two sets of linear bearing blocks 32,33;34,35 are also arranged in parallel and spaced apart in the direction perpendicular to the longitudinal axis of the lower slide base member 22, thus in the Y-axis direction of the CNC X-Y table, on top of the lower slide base member 22. Thereby is delimited a lower space 36 for arranging at least some of the components of the lower linear actuator 24 between the at least two lower linear bearing block means. And thereby is the lower bridge member 26 allowed to slide between parallel sets of linear bearing blocks 32,33;34,35 along the lower actuator rod 25, thus along the X-axis.

The lower bridge member 26 has a lower slide bearing 37. On top of the lower slide bearing 37 is a lower securing plate 38, which has third through-holes 39 aligned with fourth through-holes 40 of the lower top slide member 23. The lower slide bearing 37 has a first lower bore 41 inside which the lower drive nut 50 is arranged and secured to drive the lower bridge member 26 along the lower actuator rod 25 in a controlled manner. For the securing purpose the lower drive nut 50 has an upright securing peg 51 secured in a lower peg hole 52 of the lower securing plate 38.

Opposite the lower bearing housing 27 the free end 42 of the lower actuator rod 25 is seated in a lower front bushing 43. Said free end 42 is secured, e.g. by means of screws or bolts through appropriately aligned holes, to the free end 44 of the lower slide base member 22.

A lower securing flange 45 of a gear box 46 of the lower linear actuator 24 is secured to a rear end 47 of the lower bearing housing 27, thereby aligning a second lower bore 48 of said lower bearing housing 27 with the first lower bore 41 of the lower bridge member 26. In this position the lower bearing housing 27 protrudes from the gear box 46 to cover the lower clutch mechanism 49.

The front end part 53 of the lower bearing housing 27 opposite the rear end 47 has opposite laterally protruding securing webs 54 on opposite lengthwise extending sides 55. The front end part 53 is forged due to two chamfered, parallel, lower slide legs 56a,56b. A lower receiving space 57 between said lower slide legs 56a,56b provides a space for receiving the lower slide bearing 37 of the lower bridge member 26. The free end 58 of the lower securing plate 38 that faces the lower bearing housing 27 is chamfered complementarily to the chamfering of the lower slide legs 56a,56b thereby allowing the lower bridge member 26 to slide in partly overlapping relationship with the lower bearing housing 27, as seen best in the views of FIGS. 12 and 13, thereby maximizing the largest possible travel distance of the lower bridge member 26, and thus of the lower drive nut 50, while maintaining a secure assembling of the lower bridge member 26 and the lower drive nut 50, whereby also a more compact construction is obtained.

The opposite laterally protruding securing webs 54 each has fifth through-holes 59, and the lower slide base member 22 has two corresponding sets of sixth through-holes 60 for securing of the lower slide legs 56a,56b on opposite sides of a clearance 30 of the lower slide base member 22 for the lower slide bearing 37. The end 61 opposite the free end 44 of the lower slide base member 22 has a lower mounting recess 62 provided in extension of the clearance 30 of the lower slide base member 22 to receive a nose part 63 of the lower bearing housing 27. The lower mounting recess 62 is provided in a smaller extension 64 of the lower slide base member 22. Seventh through-holes 65, which are provided retracted from the smaller extension 64, on opposite sides of the clearance 30, serve for assembling with aligned eight through-holes 69 provided in the lower slide legs 56a,56b. The lower mounting recess 62 advantageously serves as a rear seat for the nose part 63 of lower slide bearing 37 in said lower slide bearing 37's retracted position. Ninth through-holes 70 in the main body of the lower bearing housing 27 serves for securing of the clutch mechanism 49.

The lower slide means 31 further has a lower male slide means 71. In the present embodiment the lower male slide means 71 is configured as two parallel spaced apart lower guide rails 71a,71b to slidingly engage with the respective lower tracks 32a,33a;34a,35a of a respective set of the two parallel sets of lower linear bearing blocks 32,33;34,35.

As also seen in the end views of FIGS. 14 and 15 the two parallel spaced apart lower guide rails 71a,71b are secured in two spaced apart lower guide tracks 72a,72b provided in the lower face 23a of the lower slide top member base plate 23b of the lower slide top member 23 using screws or bolts (not shown) through aligned threaded tenth holes 73 and eleventh through-holes 74, respectively, as seen in FIG. 9. The upper face 23c of the lower slide top member base plate 23b has four lengthwise extending, parallel, spaced apart slide grooves 75a that constitute a second sliding means of the lower top slide member 23, which second sliding means serves for slidingly securing of the upper linear slide mechanism 18 and the laser pointer assembly 21.

The lower slide top member base plate 23b of the lower slide top member 23 has opposite lower slide top member side plates 76a,76b extending along the length of said lower slide top member base plate 23b thereby defining a U-profile that encases the lower linear slide mechanism and protects the components of said lower linear slide mechanism during operation.

FIGS. 16-19 are perspective views of the upper linear slide mechanism 18. The operation and structure of the upper linear slide mechanism 18 corresponds substantially to the operation and basic structure of the lower linear slide mechanism 17, and a less detailed description of the upper linear slide mechanism 18 is therefore given below.

The upper linear slide mechanism 18 has an upper slide 79 comprising an upper slide base member 77, an upper slide top member 78 with a U-profile, and an upper linear actuator 80 having an upper actuator rod 81.

As seen best in FIGS. 19 and 21 an upper bridge member 82 is operatively connected to an upper drive nut 83, and an upper clutch mechanism 84 is placed in an upper bearing housing 85.

An upper slide means 86 is comprised of an upper female slide means 87 and an upper male slide means 88. The upper female slide means 87 is comprised of an upper linear bearing block means in form of two parallel sets of upper linear bearing blocks 89,90;91,92 each having a respective upper track 89a,90a;91a,92a. Two respective upper linear bearing blocks 89,90 and 91,92 of the upper female slide means 87 of a set of upper linear bearing blocks 89,90;91,92 are mounted spaced apart along the longitudinal axis of the upper slide base member 77, thus along the Y-axis of the CNC X-Y table.

Second mounting holes 89b,90b;91b,92b of said upper linear bearing blocks 89,90;91,92 are aligned with twelfth through-holes 89c,90c;91c,92c of the upper slide base member 77, whereby the two sets of upper linear bearing blocks 89,90;91,92 can be secured in parallel firmly onto the upper slide base member 77 using screws or bolts (not shown) through said aligned second mounting holes 89b,90b;91b,92b and said twelfth through-holes 89c,90c;91c,92c. The upper actuator rod 81 is expediently disposed between the two parallel sets of upper linear bearing blocks 89,90 and 91,92 and extends along the Y-axis in the assembled stated of the CNC machining apparatus 14 of the present invention.

The upper male slide means 88 comprises at least two spaced apart upper guide rails 93a,93b slidingly arranged in the respective upper tracks 89a,90a;91a,92a of the two parallel sets of upper linear bearing blocks 89,90;91,92.

Emphasis is made that the options and provisos made in relation to the lower linear slide mechanism regarding number, arrangement and reversing of bearing blocks and tracks also applies for the upper linear slide mechanism.

The upper bridge member 82 has thirteenth through-holes 94a,94b for securing it to fourteenth through-holes 99a,99b in the upper slide top member base plate 96 of the upper slide top member 78 via its lower face 95, thereby enabling the upper bridge member 82 to bring along said upper slide top member 78 when an upper servo motor 97 of the upper linear actuator 80 is operative to move the upper drive nut 83, which is secured inside an upper bore 98 of the upper bridge member 82.

Said upper bridge member 82 is brought along when the upper drive nut 83 is moved along the Y-axis of the CNC X-Y table, thus along the upper actuator rod 81. The upper actuator rod 81 is e.g. a spindle threadingly engaging the upper drive nut 83. The upper bridge member 82 and the upper bearing housing 85 are seen in more details in FIG. 20.

The lower face 95 of the upper slide top member base plate 96 has two parallel spaced apart upper guide tracks 100a,100b to which the upper guide rails 93a,93b are secured, thereby guiding and controlling the linear motion of said upper guide rails 93a,93b when the upper linear actuator 80 are operative.

The upper guide rails 93a,93b have fifteenth through-holes 101a,101b for said securing of said upper guide rails 93a,93b into sixteenth through-holes 102a,102b in the upper slide top member base plate 96 via its lower face 95.

The upper slide base member 77 has a lower face 103 and an opposite upper face 104. The lower face 103 conveniently has a first sliding means in form of at least one upper male slide means 88. The upper male slide means 88 is in the present embodiment four spaced apart slide shoes 105a,105b,105c,105d secured in corresponding recesses 106a,106b,106c,106d in the lower face 103 by means of screws or bolts (not shown) through appropriate sixteenth through-holes 107a,107b,107c,107d. The slide shoes 105a,105b,105c,105d are configured to slidingly engage with two of the four lengthwise extending, parallel, spaced apart slide grooves 75a of the second sliding means of the lower top slide member 23. Preferably the at least one slide shoe comprises at least two parallel sets of individually spaced apart slide shoes 105a,105b,105c,105d that slide the upper linear slide mechanism along the X-axis on top of the lower top slide member 23.

The upper face 104 upper slide base member 77 has two upside down T-slots 75b that can be utilised for securing of another means or another component.

The upper bearing housing 85 is secured to the upper slide base member 77 using screws and/or bolts (not shown) through aligned seventeenth through-holes 108 and eighteenth through-holes 109, respectively.

The upper slide base member 77 has upper lateral flanges 110a,110b for securing it to the slide grooves 75a of the lower top slide member 23.

The tool holder 19 has a lower tool holder part 110 and an upper tool holder part 111.

The lower tool holder part 110 is symmetrical along the Y-axis of the CNC X-Y table. The lower tool holder part 110 has a first tool holder leg 112, that has an L-profile and an opposite second tool holder leg 113 that has a mirror L-profile. The first tool holder leg 112 and the second tool holder leg 113 have opposite ends, which are interconnected by a third tool holder leg 114, which also has an L-profile. The third tool holder leg 114 may be optional but is preferred to cover the end of the upper slide top member 78. The foots 112a,113a,114a of the U-shaped tool holder's legs 112,113,114 constitute a continuous squared flange of the tool holder 19, and the opposite corresponding upright legs 112b,113b of the L-shaped tool holder legs 112,113 serve for securing of the tool piece 20a and securing of the lower tool holder part 110 to any of the respective opposite upper slide top member side plates 115,116 of the upper slide top member 78. Although just one tool piece is seen in FIGS. 22 and 24 the tool holder 19 can carry two tool pieces 20a,20b at the same time, e.g. simply also carrying an inactive and/or active tool piece suited for another machining process. Two tool pieces can be operative at the same time and different tool pieces can be used as appropriate. Although the tool holder is shown with two tool pieces more than two is within the scope of the present invention.

The respective opposite upper slide top member side plates 115,116, that on opposite edges along the length of the upper slide top member extend into the upper slide top member base plate 96, defines a cover with an upper U-profile that delimits an upper cavity 117, thereby covering and protecting at least parts of the upper linear actuator 80, the upper female slide means 87, the upper male slide means 88, the upper bearing housing 85 and the upper bridge member 82.

The laser function of a laser pointer is known to the skilled person and will not be described in further details, however how the laser pointer assembly of the present invention is configured, mounted to the CNC machining apparatus, and is aligned for use, is novel and inventive, and is discussed in details below.

The laser pointer assembly 21, which is also seen in FIG. 8, is pivotable hinged to a hinge 118, which hinge 118 is arranged slidingly along the slide grooves 75a, thus along the X-axis of the CNC X-Y table, to be secured in a suitable aligning position in relation to the rotating part of the object that is to be machined, as a means to align the CNC X-Y table. The hinge 118 allows the laser head 139 of the laser pointer 144 to be pivoted about said X-axis, and be tilted away from the object to get sufficient space to unhindered rotate the laser head 180° during the aligning process, and tilted back again to control the aligning of the CNC machining process. The aligning process can thus be performed without needing to demount the laser pointer assembly 21 from the slide grooves 75a of the lower slide top member 23. The laser pointer assembly 21 and the aligning of the X-axis of the CNC X-Y table using said laser pointer assembly will be described in further details below with references to FIGS. 28-30.

The hinge member 15, which is e.g. seen in assembled state in FIG. 6, has an object securing part 119 which is pivotable hinged to a CNC machining apparatus securing part 120 by means of a pivot shaft 121. The CNC machining apparatus securing part 120 has a securing table 122 that is the part being secured to the CNC base 16. Opposite pivot legs 123a,123b, of which just one is visible in FIG. 25, protrude from the securing table 122 towards the object securing part 119 to be pivotable secured to opposite hinge legs 124a,124b of the object securing part 119. To that aspect each pivot leg 123a,123b has a curved pivot track 125a,125b aligned with a plurality of position adjusting holes 126a,126b provided in same curvature as the curved pivot track 125a,125b for securing the pivoted securing table 122 firmly in the selected pivoted position. The CNC machining apparatus securing part 120 is pivoted in the curved pivot tracks 125a,125b until the angle between the tool pieces and the rotating part 3 to be machined is in the desired appropriate machining angle for the machining process. Then the X-axis of the X-Y table is aligned parallel to the rotation axis R of the rotating part as described below with the help of the laser pointer assembly 21 and by turning of the CNC base 16 with the lower linear slide mechanism on top of it using adjustments screws 16b to push on the CNC machining apparatus securing part 120.

To that aspect the CNC base 16 has a centre pin 16a, see FIG. 6, that engages a rotation hole 15a in the hinge member 15 thereby facilitating turning of the lower linear slide mechanism 17 that is secured to the CNC base 16, and thus turning of the CNC X-Y table, in relation to the CNC machining apparatus securing part 120 of the hinge member 15, to conduct a final aligning of the X-axis to make the X axis of the X-Y table parallel to the rotation axis of the rotating part. Said aligning of the CNC base 16 takes place by means of adjusting screws 16b at the corners of the CNC base 16. The adjusting screws 16b act on the edges of the CNC machining apparatus securing part 120 to turn the combined CNC base 16 and lower linear slide mechanism 17 on the hinge member 15 in alignment parallel to the rotation axis of the rotating part of the object, thus aligning the X-axis of the CNC X-Y table in parallel with said rotation axis, thereby also having arranged the tool piece(s) in its/their cutting position against the rotating part,—the wheel 3.

FIG. 28 is an enlarged perspective view of the improved laser pointer assembly 21 of the present invention used on the CNC machining apparatus 14 of the present invention. The laser pointer assembly 21 serves as an improved means to tune the X-axis of the CNC X-Y table in alignment of with the target, and with said rotation axis.

The hinge 118 of the laser pointer assembly 21 has a hinge base plate 132 having a first hole 133 for detachable securing of said hinge base plate 132 into the slide grooves 75a of the lower slide top member 23 in a selected position using screw(s), tab(s) or bolt(s). The hinge base plate 132 constitutes the bottom of a bracket 135 having opposite bracket side parts 136a,136b. The bracket side parts 136a,136b have pivot ends 137a,137b through which respective pivots 138a,138b extend to keep the laser head 139 pivotable suspended in relation to the lower slide top member 23. Only one pivot 138a is visible in FIG. 28, but it is obvious to the person skilled in the art that a corresponding pivot 138b is associated with the opposite bracket side part 136b.

The laser head 139 is secured to the hinge 118 via a suspension means 140. The suspension means 140 comprises an outer turnplate 141 and an inner turnplate 142, which outer turnplate 141 is rotationally arranged in relation to the inner turnplate 142 about a laser assembly rotation axis H. The inner turnplate 142 is pivotable hinged to the pivot ends 137a,137b of the bracket side parts 136a,136b. The outer turnplate 142 carries the laser head 139 of the laser pointer 144, whereby also the laser head 139 becomes rotational about the laser assembly rotation axis H without the need of detaching the hinge base plate 132 from the lower linear slide mechanism 17 when alignment of the X-axis of the CNC X-Y table is done.

FIGS. 29 and 30 show the calibration process of the X-axis of the CNC machining apparatus 14 of the present invention using the laser pointer assembly 21 of the present invention in initial zero position and in the subsequent position rotated 180° about the laser assembly rotation axis H.

The laser pointer assembly 21 may be placed substantially along the Y-axis, in which case the upper linear slide mechanism may or may not be mounted on top of the lower linear slide mechanism, as shown in FIG. 30, or be placed in a plane parallel to the Y-axis.

The laser light beam B is issued by the laser head 139. In FIG. 30 Ref. 1 is a reference position in which the X-axis of the CNC X-Y table is closest to the target (the pulley wheel) to be machined, and Ref. 2 is a reference position in which the X-axis of the X-Y table is farthest away from the target to be machined. Ref. 1 and Ref. 2 span the diameter of the pulley wheel to make measurements at opposite sides of the pulley wheel. If the X-axis of the CNC X-Y table is offset perpendicular to the target, then, by means of the adjusting screws 16b at the corners of the CNC base 16, the lower linear slide mechanism 17 can be turned an angle, either towards or away from the target to be machined, as required, to reach an orientation of the lower linear slide mechanism in required alignment with the target. Preferably alignment means that the attack angle of a tool piece is perpendicular to the X-axis, and preferably so that the X-axis of the CNC X-Y table is parallel to the rotating axis of the pulley wheel.

Once this aligning has been made the aligning is repeated with the laser head 139 rotated 180°, as represented by Ref. 2 in FIG. 30, and the position of the X-axis in relation to the target is adjusted and tuned again using the adjusting screws 16b, if needed, to assume an aligning of the CNC X-Y table in which there is no deviation of the angle measured closest to the target from the angle measured farthest from the target. This aligning can be repeated as frequently as appropriate, and is performed each time a new object is machined.

When the average distance between Ref. 1 at 0° and Ref. 1 at 180° is equal to the average distance between Ref. 2 at 0° and Ref. 2 at 180° the X-axis is oriented in its correct machining position at a machine angle substantially perpendicular to the target.

In the present Example of FIG. 30 Ref. 1 at 0° is 313 mm and Ref. 1 at 180° is 277 mm, which gives an average of 295 mm. Ref. 2 at 180° is 186 mm and Ref. 2 at 180° is 404 mm which also gives an average of 295 mm, thus the lower linear slide mechanism, and thus the X-axis of the CNC X-Y table, is perpendicular to the central plane of the target, and parallel to the rotation axis of the target,—the pulley wheel. So now the Y-axis of the CNC machining apparatus is perpendicular to the tracks of the pulley wheel to be machined, and so is the tool piece.

The huge advantage of the laser pointer assembly of the present invention is that it need not be detached the lower slide top member 23 and remounted to make the control aligning at the 180° position. Any turning of the laser head 139 can be done without demounting the laser pointer assembly 21 from the lower slide top member 23. Further, the laser pointer assembly 21 can be mounted and situated on the lower slide top member 23 together with the upper linear slide mechanism 17 with the tool holder. So none of the upper linear slide mechanism and the tool holder needs to be demounted in order to have space for the laser pointer assembly.

The laser pointer assembly and the upper linear slide mechanism that carries the tool holder are both mounted in the slide grooves 75a of the lower slide top member 23. Said slide grooves 75a have an upside down T-profile with free access openings of smaller width than their bottoms, as seen in e.g. FIG. 15. So when a complementarily shaped sliding component, of e.g. the laser pointer assembly 21 or of the upper slide base member 77, is inserted into said slide grooves 75a from a free end of the lower slide top member 23 the laser pointer assembly 21 and the upper linear slide mechanism 18 cannot drop out due to gravity when the X-Y table is turned upside down to e.g. machine a lower pulley wheel of a band saw. Instead the laser pointer assembly 21 and the upper linear slide mechanism 18 are held firmly secured in the slide grooves 75a due to the complementary shaped mutually engaging slide components. Any complementary shapes are within the scope of the present invention provided said complementary shapes can hold two engaging objects together when the male component are subjected to gravitational forces.

On the known CNC machining apparatus only one of the laser pointer or the tool holder can be secured to the apparatus at the time and only in fixed positions defined by a fixed hole pattern.

The rotation of the laser head 139 is very fast, e.g. 1-2 seconds, whereby the entire aligning process is made very fast as well. The faces of the inner turnplate 142 and the outer turnplate 141 that faces each other may have opposite mechanical, preferable adjustable, means to lock the rotation of the outer turnplate 141 in fixed predetermined position in relation to the inner turnplate 142. As an example of such a mechanical means can be mentioned attracting magnets. So when the outer turnplate 141 has been rotated 180° the opposite attracting magnets are in magnetic contact thereby temporarily locking the outer turnplate 141 to the inner turnplate 142. No magnets are seen in the figures.

The laser pointer can be of different kinds. The laser pointer can e.g. be of the line laser type or be of the rotary laser type. The laser pointer may advantageously be used with a “reading unit” that is placed on a measuring point at the rotating part to be machined, and which provides a readout to be used in the aligning with a deviation of typically as good as about 0.001 mm.

A very simple way of using a line laser may be simply issuing the laser beam and measuring the distance to the rotating part using a ruler. Yet an alternative is to mount and use a straightedge on the CNC X-Y table. Using any of these simple methods will result in an aligning with a higher deviation value than obtainable by the laser pointer assembly of the present invention on the CNC apparatus of the present invention, which however may be acceptable for machining some parts.

The laser pointer assembly of the present invention is detachable and can easily be fixed to the mobile CNC machining apparatus of the present invention.

Due to the novel and inventive laser pointer assembly of the present invention the tool piece(s), such as cutting tools, can be arranged at an optimum calibrated machining position in relation to the rotating part, that is the target to be machined, at very short time and using minimum tools and efforts.

FIG. 26 shows the CNC machining apparatus 14 on a bench 127 making it into a turning lathe 128. The bench 127 with or without the CNC machining apparatus 14 can easily be transported around to machine various parts on various work places, e.g. at the sawmill, as an alternative to utilizing the CNC machining apparatus as described above mounted directly on the object having the rotating part to be machined. It may be more profitable or easier to use the turning lathe instead for machining some parts and/or for some machining processes.

In particular very large parts having diameters above 900 mm may advantageously be taken off and machined out of the object.

A large pulley wheel is such an example, however other kinds of machinery and objects having parts to be subjected to maintenance by machining is within the scope of the present invention. A pulley wheel can be taken off the band saw, to e.g. be machined at a location remote from the sawmill or at the saw mill, e.g. at times when the band saw is normally out of use, such as e.g. during the night, to save downtime, or be machined on its work location using the turning lathe 128.

The turning lathe 128 with the CNC machining apparatus 15 can, as mentioned above, be a mobile combined or not combined unit that can be lifted by a truck or crane, and be transported to any desired location of use. This property is particular advantageous if the part to machined cannot be dispensed with for longer times, or has essential functionalities that need to be considered in relation to the machining process, optionally being considered by mimicking the conditions and mode of use. The option of being able to take a rotating part off its object, e.g. a pulley wheel off the band saw, and machine said rotating part using the turning lathe, is sometimes easier and faster than mounting the CNC machining apparatus to the object and perform the machining without demounting the rotating part, in which latter case the operator may need to demount some parts of the object to be able to mount the CNC apparatus correct.

Thus a further essential concept of the present invention is the ability to machine a rotating part at its work location when the rotating part is taken off the object. If the customer cannot afford to have his equipment, such as the object with the rotating part, out of operation for longer times the rotating part can advantageously be machined on location. Further the machining process can be of such a complicated nature that machining with the CNC machining apparatus mounted on the object is not only impractical but also inconceivable.

The solution is the turning lathe composed of a mobile or moveable bench with a CNC machining apparatus mounted thereon, which turning lathe is transported to the work location to save transport time and downtime of the object utilizing the rotating part to be machined. The bench provides the required rigidity to the mobile or moveable turning lathe to support the CNC machining apparatus in operation. So the mobile or moveable turning lathe of the present invention is typically used to machine rotating parts that are so large that they are difficult and expensive to transport, or to machine rotating parts where the working or operating conditions need to be copied and/or considered to be able to perform a high-precision machining. When rotating parts are worn their profile changes. Such changes are much easier taken into account if the rotating part can be machined on the location of the object and can be put back in same orientation and same position on the object immediately after completing of the machining. A test run may be performed, and re-machining performed if needed, without such extra work takes too much time, as if it would have done if the rotating part was machined distanced from the work place.

So the mobile turning lathe enables the operator to perform the machining next to the object and to mount the machined rotating part to the object again immediately after the machining process has been completed.

A crane may be mounted on, or be mountable to, the bench 127 to lift a heavy rotating part in mounted position on the rotating shaft 129 and off the shaft again.

The pulley wheel 3 is taken off the band saw and mounted to the rotating shaft 129 of the turning lathe 128 to be directly driven in rotation by an electric motor (not shown). The CNC machining apparatus 14 is mounted to a displaceable bench table part 130 of the bench 127, which displaceable bench table part 130 has a plurality of bench notches 131 for selective positioning of the CNC machining apparatus 14 at different distances to the rotating shaft 129. A first bench table part 130 of the bench 127 may be extended by attaching one or more further bench table parts (not shown) to the end of the bench table part 130 opposite the rotating shaft 129.

FIG. 27 corresponds to FIG. 26 but the displaceable bench table part 130 has been retracted from the rotating shaft 129, whereby the distance between said rotating shaft 129 and the CNC machining apparatus 14 has been increased, thereby illustrating the ability of the turning lathe to be adapted to machine rotating parts of larger radius than the shown pulley wheel 3, e.g. rotating parts having diameters of about 1500 mm, or even higher. Machining smaller diameter parts are however also possible by means of the turning lathe of the present invention.

The bench 127 is secured to a main support 145. Preferably the main support 145 is a welded structure. Preferably the main support 145 is build-up of two spaced apart rigid frames 146a,146b having opposite plate members that serve as vibration dampers. The rigid frames 146a,146b are rigidly joined, e.g. by means of transverse members 147 whereby vibrations are avoided to the highest possible extent. The main support 145 is structurally rigid and structurally stable even when used for machining large parts.

The main support 145 is detachably secured to a foundation 148. The foundation has opposite legs 149a,149b that are longer than the width of the main support 145. In the views seen in FIGS. 26 and 27 the legs 149a,149b protrude below the pulley wheel 3 and define the limit for the radius of the wheel 3 that can be machined. However by simply turning the main support 180° in relation to the foundation the legs 149a,149b will protrude in the opposite direction, thus not below the pulley wheel 3, whereby the turning lathe can be used to machine extremely large parts. If the space below the ground or floor, on which the foundation is placed, still is too little to machine a very large part, without said very large part hits on the ground or floor, an additional rigid structure can be inserted between the foundation and the ground or floor to add extra height to lift the turning lathe further above the ground or floor, wherein the additional rigid structure and the foundation are securely joined to each other. In the alternative main supports of different heights can be used.

The legs 149a,149b may be bolted to the foundation 148, or to the extra structure, to ensure that the turning lathe 128 does not move when in operation, however the weight of the turning lathe 128 may suffice in itself to prevent such undesired moving around.

In FIGS. 26 and 27 the X-axis is oriented parallel to the axis of the rotating shaft 129 and the Y axis is oriented parallel to the displacement axis of the displaceable bench table part 130. However the opposite arrangement is also within the scope of the present invention, e.g. being convenient in case of surface working.

Furthermore a plurality of different fixtures, brackets and other tools can be mounted to the turning lathe 128, to parts of the turning lathe 128, and to the CNC machining apparatus 14, due to the many holes that offer assembling of parts and components of the turning lathe 128 and of the CNC machining apparatus 14 in various positions and orientations, as well as for additional components and equipment.

The arrangement of aligned through-holes for securing opposite components, parts, members and elements ensures that the corresponding components, parts, members and elements do not get loose during operation of the CNC machining apparatus 14, and that the vibrations induced to the CNC machining apparatus 14 by the rotation force of the rotating part of the object are eliminated to the best possible extent. Assembling of components can take place using bolts or screws. Some components that are not intended to move could however be made integral with each other or be welded together. However by using separate components, replacement of components and regular maintenance, such as inspection of the components, parts, members and elements, can more easily be performed, whereby substantial costs are saved.

FIG. 31 shows the turning lathe 128 seen in FIG. 27 equipped with vibration damper means 132.

A rotating pulley wheel 3 being machined when still on the band saw is supported by the saw blade. However a rotating pulley wheel 3 being detached from the band saw, or similar rotating object to be machined, using the turning lathe 128 of the present invention, has no support along its perimeter or edge during the machining process. The rotating pulley wheel 3 or other object may vibrate or oscillate when the at least one tool piece 20a,20b acts on its edge/perimeter during machining, which in some implementations could cause a substantial decrease in machining quality. So such vibrations and/or oscillations should preferably be at a minimum, thus mitigated or eliminated. The solution to reduce, or even eliminate, vibrations or oscillations transferred to the rotating pulley wheel 3 or object when subjected to the forces and action of the tool piece 20a,20b is to apply a small pressure to the rotating pulley wheel 3 or object. The vibration damper means 132a,132b,132c can e.g. be pads or blocks acting on one or more points at or in the vicinity of the edge of the rotating object. The vibrations damper means can e.g. be one or more pressure pads or blocks suspended on a support (not shown) in front of the object and distributed circumferentially spaced apart to apply a pressure force as indicated by fat arrows in FIG. 31. The direction of the pressure force may be parallel to the axis of rotation, thus normal to the perimeter/edge of the rotating pulley wheel 3 or other similar rotating object.

Three pressure pads 132a,132b,132c can eg. be arranged spaced equally apart at angular intervals of 120°, as illustrated by way of principle sketch in FIG. 31. For smaller diameter objects one pressure pad may suffice and applied where appropriate in front of the circumferential edge of the rotating object to apply a pressure force onto the plate face at said edge or close to said edge. Any number of pressure pads, and spacing therebetween, whether it be same or different spacings, are within the scope of the present invention. Thus large objects may need more than three pressure pads, and more pressure pads than small objects, in order to be properly supported during machining.

The pressure pads 132a,132b,132c may be of any suitable material, such as plastic, would, metal, or composite. The pressure pads 132a,132b,132c may have a friction-reducing coating, such as a Teflon coating to avoid reducing rotational speed of the turning lathe 128.

Preferably a first pressure pad 132c is normally positioned as close to the tool piece 20a,20b as possible to eliminate vibrations and oscillations as closed to their origin as possible. Further pressure pads 132a,132b may be arranged according to actual machining situations. The pressure pads may e.g. be moveable or detachable mounted to a rigid frame (not shown) in order to be placed in customized manner.

In the embodiment seen in FIG. 31 the first pressure pad 132c is arranged in front of and in pressing contact with the object on a line L1 that extends parallel to the X axis and perpendicular to the axis of the shaft 129. The second 132a and third pressure pad 132b are arranged spaced apart at equal distance about line L1 along line L2, which is perpendicular to the X axis, whereby the three pressure pads 132a, 132b, 132c creates the pattern of a vibration absorbing triangle. Said vibration absorbing triangle may be equilateral or isosceles, in which latter case the legs of equal lengths are the legs sharing the first pressure pad 132c.

The force applied by the pressure pad(s) 132a,132b,132c may offset the plane of the object as little as about 0.5 mm away from the cutting table. Such a small offset is often sufficient to compensate for induced vibrations. Larger or smaller offsets may be applicable for different rotational speeds of the object, selected metal cutting/machining speed, and kinds of objects.

Cutting speed is generally defined as the relative velocity between the surface of the workpiece, thus the rotating object to be machined, and the cutting tool piece. Machinists measure Cutting speed in meters per minute (m/min). Thus the cutting speed in respect of the present invention is the relative velocity that the object to be machined (e.g. a pulley wheel) rotates with in relation to the tool piece. Accordingly, the cutting speed of the present invention is the velocity at the perimeter of a rotating object or at other attack point of the tool piece.

Feed per Revolution is within the context of the present invention the linear distance that the cutting edge of the tool piece travels during a single rotation of the workpiece.

The Feed Speed (Also called Table Feed or Milling Feed Rate), is the linear velocity of a tool piece relative to the workpiece.

At optimum cutting speed the machining process achieves the best result, but the faster the machining can take place in view of preserving high machining quality the less costs and time need to be invested in the machining process.

Cutting speeds of the present invention may be in the range of 100-1500 m/min, and application of the vibration damper does not affect even the high end of this range of cutting speed.

The below Table shows the improvement in cutting properties of the CNC machining apparatus (referred to as CNC 2.0 in the Table) according to the present invention compared to the CNC machining apparatus (referred to as CNC 1.4 in the Table) according to the applicant's international patent application no. PCT/DK2004/000535 for machining two pulley wheels of different dimensions: Pulley wheel 1 (diameter: 1100 mm; width 110 mm) and Pulley wheel 2 (diameter: 1500 mm; width 170 mm).

TABLE

| CNC machining apparatus | CNC 1.4 | CNC 2.0 | CNC 1.4 | CNC 2.0 | CNC 2.0 |
|---|---|---|---|---|---|
| (A) Wheel diameter (mm) | 1100 | 1110 | 1500 | 1500 | 1500 |
| (A1) Wheel width (mm) | 110 | 110 | 170 | 170 | 170 |
| (B) Cutting speed (m/min) | 130 | 900 | 150 | 1200 | 1200 |
| (B1) Corner radius of tool piece (mm) | 0.4 | 0.4 | 0.4 | 0.4 | 0.8 |
| (C) Rotational speed of wheel (rpm); | 37.64 | 260.57 | 31.58 | 254.78 | 254.78 |
| (A × π/B) | | | | | |
| (D) Feed speed (mm/min) | 11 | 76 | 10 | 76 | 120 |
| (E) Feed per revolution; (D/C) | 0.2923 | 0.2917 | 0.2983 | 0.2983 | 0.4710 |
| (F) Machining time per machining cycle | 10.000 | 1.4474 | 17.8947 | 2.2368 | 1.4167 |
| (min); (A1/D) | | | | | |

As the new CNC machining apparatus of the present invention is much more stable and vibrates much less than the older CNC machining apparatus described in international patent application no. PCT/DK2004/000535 it is possible to use a tool piece having a large corner radius thereby reducing machining time per machining cycle.

As can be concluded from the last row of the Table machining of a pulley wheel having a diameter of 1100 mm and a width of 110 mm can be reduced from 10 min to about 1.5 min by using the new innovative CNC machining apparatus of the present invention. A pulley wheel having a diameter of 1500 mm and a width of 170 mm is machined for about 18 min when using the old CNC machining apparatus with a tool piece having a corner radius of 0.4 mm. With the same tool piece on the new CNC machining apparatus it only takes about 2.2 min. When using a tool piece having larger corner radius the new CNC machining apparatus performs the machining job even faster using only about 1.4. min.

It should however be noted that the CNC machining apparatus of the present inventions performs well at any desired cutting speed. Cutting speed outside the range 100-1.500 m/min are also within the scope of the present invention. For some rotating objects the cutting speed may even be between 1.500-3.000 m/min.

The high-speed machining of the present invention increases the rate and speed of material cutting which reduces excessive heat loss and transfer with the result of energy consumption being low. The CNC machining apparatus of the present invention therefore has increased productivity rates, cuts more precise, and more stable, meaning that more objects can be machined within a shorter period than hitherto possible and with a higher quality than with known CNC machining apparatuses.

The CNC machining apparatus may be used in a method of crowning a band saw pulley wheel comprising: mounting the CNC machining apparatus to e.g. the frame of the band saw, mounting at least one tool piece to the tool holder, aligning the CNC X-Y table and said tool piece with the pulley wheel to be crowned using a laser pointer assembly mounted to the lower linear slide mechanism, driving the pulley wheel into rotation, and starting the crowning operation to crown the pulley wheel. The CNC machining apparatus can be programmed, e.g. such that once the crowning operation is started the tool piece is brought into contact with the surface of the pulley wheel and then follows a specific path such that the pulley wheel is crowned with a specific profile.

1-22. (canceled)

23. A CNC machining apparatus configured for machining a rotating part of an object, the CNC machining apparatus comprises:
a hinge member adapted to be secured to the object, and
a CNC X-Y table securable to the hinge member,
wherein the CNC X-Y table comprises:
a CNC base which is adapted for being rotationally secured to the hinge member (15),
a lower linear slide mechanism adapted to be secured in a selected lower working position on top of the CNC base,
the lower linear slide mechanism comprises a lower slide having a lower slide axis defining the X-axis and being arranged to slide in relation to the CNC base,
an upper linear slide mechanism adapted to be secured in a selected upper working position on top of the lower linear slide mechanism,
the upper linear slide mechanism comprises an upper slide having an upper slide axis defining the Y-axis and being arranged to slide perpendicular to the lower slide, and
at least one tool piece which is attachable to the upper slide,
wherein the lower linear slide mechanism comprises a lower slide base member, a lower slide top member, and a lower linear actuator at least partly disposed between said lower slide base member and said lower slide top member,
wherein the lower slide base member comprises:
first securing means for being secured to the CNC base opposite the hinge member, and
second securing means for securing of a lower slide means,
the lower slide means comprises:
a lower female slide means selectively securable to the lower slide base member, and
a lower male slide means configured to slidingly engage with the lower female slide means, and
wherein the lower linear actuator is operatively connected to the lower male slide means and to the lower slide top member to slide said lower slide top member along the X-axis.

24. A CNC machining apparatus according to claim 23, wherein the upper linear slide mechanism further comprises a tool holder for the at least one tool piece, optionally the tool holder is detachable from the upper linear slide mechanism.

25. A CNC machining apparatus according to claim 24, wherein the lower female slide means comprises at least two lower linear bearing block means having respective lower tracks, wherein the at least two lower linear bearing block means are arranged in parallel and spaced apart on top of the lower slide base member thereby delimiting a lower space for arranging of at least a part of the lower linear actuator between the at least two lower linear bearing block means, preferably the at least two lower linear bearing block means are comprised of at least two spaced apart sets of lower linear bearing blocks, wherein a set of lower linear bearing blocks are comprised of at least two lower linear bearing blocks arranged spaced apart on top of the lower slide base member.

26. A CNC machining apparatus according to claim 25, wherein:
the lower male slide means comprises at least two spaced apart lower guide rails slidingly arranged in the respective lower tracks of the at least two lower linear bearing block means,
a lower face of the lower slide top member is configured with at least two spaced apart lower guide tracks for partly accommodation of said respective at least two spaced apart lower guide rails, and
a lower bridge member, which is secured to the lower face of the lower slide top member, is configured to slide along a lower actuator rod of the lower linear actuator in response to operating the lower linear actuator.

27. A CNC machining apparatus according to claim 23, wherein the upper linear slide mechanism comprises an upper slide base member, an upper slide top member, and an upper linear actuator arranged at least partly between said upper slide base member and the upper slide top member, wherein the upper slide base member has a first sliding means in form of at least one upper male slide means.

28. A CNC machining apparatus according to claim 27, wherein the upper linear slide mechanism comprises at least one upper female slide means selectively securable to the upper slide base member, and the at least one upper male slide means is configured to slidingly engage with the at least one upper female slide means.

29. A CNC machining apparatus according to claim 27, wherein the first sliding means comprises at least one slide shoe means adapted for slidingly engaging a second sliding means in form of at least one lengthwise extending slide groove of the lower top slide member, preferably the at least one slide shoe means comprises at least two parallel sets of individually spaced apart slide shoes.

30. A CNC machining apparatus according to claim 28, wherein the upper female slide means comprises at least two upper linear bearing blocks having respective upper tracks, wherein:
the at least two upper linear bearing block are arranged spaced apart on top of the upper slide base member thereby delimiting an upper space for arranging of at least a part of the upper linear actuator between the at least two upper linear bearing blocks,
preferably the at least two upper linear bearing block are comprised of two spaced apart sets of upper linear bearing blocks, wherein a set of upper linear bearing blocks are comprised of two upper linear bearing blocks arranged spaced apart on top of the upper slide base member.

31. A CNC machining apparatus according to claim 30, wherein the upper male slide means comprises at least two spaced apart upper guide rails slidingly arranged in the respective upper tracks of the at least two upper linear bearing blocks, wherein an upper bridge member is secured to the upper slide top member to slide the at least two spaced apart upper guide rails inside said respective upper tracks in response to operating the upper linear actuator.

32. A CNC machining apparatus according to claim 27, wherein the upper slide top member has an upper slide top member base plate that on opposite edges along its length extends into respective opposite upper slide top member side plates, thereby defining a cover with an upper U-profile that delimits an upper cavity for protecting and/or covering at least parts of the upper linear actuator means, the upper female slide means, and the upper male slide means.

33. A CNC machining apparatus according to claim 27, wherein the tool holder is secured to the upper slide top member.

34. A CNC machining apparatus according to claim 24, wherein the lower slide top member has a lower slide top member base plate that on opposite elongated edges extending along its length extends into respective opposite lower slide top member side plates, thereby defining a lower U-profile that delimits a lower cavity for covering at least the lower linear actuator, the lower female slide means, and the lower male slide means, wherein:
the lower slide top member base plate has an upper lower slide top member face configured with the second sliding means for selectively securing of the upper linear slide mechanism.

35. A CNC machining apparatus according to claim 31, wherein the lower bridge member receives a lower linear actuator there through, and/or the upper bridge member receives an upper linear actuator there through.

36. A CNC machining apparatus according to claim 27, further comprising a drive means for the lower linear actuator and the upper linear actuator, preferably the drive means are electric motors, preferably servo motors or step motors.

37. A CNC machining apparatus according to claim 29, further comprising a laser pointer assembly, preferably said laser pointer assembly is arranged detachable in the at least one lengthwise extending slide groove of the second sliding means of the lower slide top member, preferably alone or spaced apart from the upper linear slide mechanism, preferably the laser pointer assembly is mounted pivotable in relation to the lower slide top member.

38. A CNC machining apparatus according to claim 37, wherein the laser pointer assembly comprises a hinge and a laser head, which laser head is suspended to the hinge via a suspension means, which suspension means comprises an outer turnplate and an inner turnplate that is rotationally arranged in relation to the outer turnplate about a hinge rotation axis (H), wherein the outer turnplate carries the laser head.

39. A CNC machining apparatus according to claim 23, further comprising a processor or computer with computer software including algorithms configured to drive the CNC machining apparatus, and a user interface in communication with the computer software adapted to configure the CNC machining apparatus for a work process in response to user input data.

40. A CNC machining apparatus according to claim 23, further comprising a vibration damper means that applies a pressure force on the rotating part of an object, wherein the direction of the pressure force is parallel to the rotation axis of the shaft.

41. A band saw comprising a CNC machining apparatus according to claim 23.

42. A turning lathe comprising a CNC machining apparatus according to claim 23, preferably the turning lathe is a high precision turning lathe, preferably the turning lathe is mobile or moveable.

43. Use of the CNC machining apparatus according to claim 23 for crowning wheels, preferably for crowning pulley wheels of a band saw.
